(19) United States
(12) Patent Application Publication
(10) Pub. No.: US 2007/0181513 A1
(43) Pub. Date: Aug. 9, 2007

(54) Programmable automatic dispenser

(76) Inventor: Glen Ward, Grass Valley, CA (US)

Correspondence Address: COURTNEY STANIFORD & GREGORY LLP, P.O. BOX 9686, SAN JOSE, CA, 95157, US

(21) Appl. No.: 11/654,462

(22) Filed: Jan. 17, 2007

Related U.S. Application Data
(60) Provisional application No. 60/759,290, filed on Jan. 17, 2006.

(51) Int. Cl. A47F 1/04

(52) U.S. Cl. 211/59.2

(57) ABSTRACT

A dispensing apparatus. In an embodiment, the dispensing apparatus is configured to feed livestock such as horses and sheep. The apparatus includes a vertical structure enclosing multiple shelves. Each shelf is contemplated to hold a portion of feed to be dispensed at a predetermined time. Each shelf is controlled by a separate actuator that is separately coupled to a programmable electronic controller. Each actuator is relatively simple in operation, and exposed moving parts are minimal. All of the actuators and associated wiring is separated from the material to be dispensed such that there is practically no possibility of material interfering with the actuator mechanisms or shelf movement. Each shelf also includes an electronic sensor that senses whether the shelf is in a first “up” or “undispensed” position, or in a second “down” or “dispensed” position. Each sensor conmmunicates the position of a respective shelf to the controller.

### RELATED APPLICATIONS

This patent application claims the benefit of U.S. Provisional Patent Application No. 60/759,290 filed Jan. 17, 2006, which is hereby incorporated by reference in its entirety herein.

### TECHNICAL FIELD

The disclosure herein relates generally to apparatus for automatically dispensing materials, and in particular for automatically dispensing feed products to animals.

### BACKGROUND

Automatic dispensing mechanisms and apparatus have been developed to dispense material from a protected store to an accessible location in a controlled manner. One application in which such apparatus are useful is automatically feeding livestock or pets over time periods when a human caretaker is not able to dispense feed. Taking horses as example, most horse owners feed their horses twice a day. Typically a portion of feed is a “flake” of hay or alfalfa broken from a bale and offered to the horse. The hay is thrown on the ground or placed in a container accessible to the horse. When the owner is not available to personally portion out the feed at the predetermined intervals, another person must take over the chore or a feeding apparatus can be employed. Typical automatic feeder apparatus include several shelves, each designed to hold a portion of food. All of the shelves are housed in a cabinet inaccessible to the horse to be fed. A mechanism dispenses portions of feed one at a time from the cabinet to an area accessible to the horse.

Currently available automatic feeding apparatus have several disadvantages. A significant disadvantage of conventional feeder apparatus is that the dispensing mechanisms are overly complex and error-prone. For example, conventional feeder apparatus have a single complex mechanism that is designed to both time the dispensing from each of the particular shelves, and also control the actual dispensing from each of the shelves. Thus, there is one operating mechanism for all of the shelves, making the shelves mechanically interdependent. For example, a single long camshaft or a single complex pulley mechanism is used to control all of the shelves. This invites operational errors or breakdowns caused by clogging of the mechanism by feed. This also invites breakdowns caused by a malfunction of one shelf disabling the entire control mechanism due to the mechanical interdependency of all of the shelves.

The complexity of current feeder designs typically requires unusually difficult assembly instruction to be executed by the user prior to using the apparatus.

Another disadvantage of some current designs is difficulty of use. For example, a current apparatus includes a single “drawer” that folds down to an open position to be loaded with several portions of feed. The drawer, when full, must be pushed up into a vertical closed position, even though it might be quite heavy.

Yet another disadvantage of conventional feeder apparatus is limited flexibility in programming the automatic dispensing time of the particular shelves. For example, the camshaft control device already been mentioned provides set feeding intervals based on cam spacing.

There is a need for a programmable, automatic dispenser that is easy to assemble, easy to use, reliable, and very flexibly programmable. There is a need for such a dispenser not only for automatically feeding livestock, but for any application in which a reliable, programmable, automatic dispensing device is a benefit.

### BRIEF DESCRIPTION OF THE DRAWINGS

In the course of the detailed description to follow, reference will be made to the attached drawings. These drawings show different aspects of the present invention and, where appropriate, reference numerals illustrating like structures, components, materials and/or elements in different figures are labeled similarly. It is understood that various combinations of the structures, components, materials and/or elements, other than those specifically shown, are contemplated and are within the scope of the present inventions.

FIG. 1 is a view of a dispenser assembly, according to an embodiment, looking slightly down toward the right side and the front;

FIG. 2 is view of a dispenser assembly, according to an embodiment, showing various shelves in the down position;

FIG. 3 is a view of a dispenser assembly, according to an embodiment, looking slightly upward toward the right side and the front;

FIG. 4 is an exploded view of a dispenser assembly, according to an embodiment, showing a subset of its components;

FIG. 5 is a cross-section of an actuator channel, according to an embodiment;

FIG. 6 is a cross-section of a hinge channel, according to an embodiment;

FIG. 7 is a view of a hinge channel and a hinge, according to an embodiment;

FIG. 8 is a view showing details of various components of a dispenser assembly, according to an embodiment, including a left side panel, a back panel, a right side panel, and an actuator channel;

FIG. 9 is a view showing details of a back panel and a right side panel, according to an embodiment;

FIG. 10 is a view showing details of a left side panel, a back panel, a right side panel, a hinge channel, and an actuator channel, according to an embodiment;

FIG. 11 is another view showing a left side panel, a back panel, a right side panel, a hinge channel, and an actuator channel, according to an embodiment;

FIG. 12 is a view of a base chute unit, according to an embodiment;

FIG. 13 is another view of a base chute unit, according to an embodiment;

FIG. 14 is a view of a base chute unit from the bottom, according to an embodiment;

FIG. 15 is a view of a top looking into the interior of a top, according to an embodiment;

FIG. 16 is view showing further detail of shelf actuating and retaining mechanisms at a point in time when an actuator is initially activated, according to an embodiment;

FIG. 17 is a view of the shelf actuating and retaining mechanisms as shown in FIG. 16, but at a later point in time;

FIG. 18 is another is a view of the shelf actuating and retaining mechanisms as shown in FIG. 17, but at a later point in time;

FIG. 19 is another view of a shelf showing a top portion of the shelf, according to an embodiment;

FIG. 20 is another view of a shelf showing a bottom portion of the shelf, according to an embodiment;

FIG. 21 is a view of various elements of shelf actuating and retaining mechanisms as previously shown, but with the shelf removed for clarity;

FIG. 22 is plan view of various components, including an actuator in a actuator channel, a door stop, a sensor magnet, and an over-travel stop, according to an embodiment;

FIG. 23 is a front view of a controller installed on a door, according to an embodiment; and

FIG. 24 is a block diagram of a controller, according to an embodiment.

### DETAILED DESCRIPTION

A programmable automatic dispenser is disclosed. In an embodiment, the dispenser is configured to feed livestock such as horses and sheep. However, in various embodiments, the dispenser is appropriate to any application that would benefit from a flexibly programmable automatic dispensing device or apparatus. In an embodiment, the dispenser includes a vertical structure enclosing multiple shelves. Each shelf contains a portion of material to be dispensed at one time. In an embodiment, the vertical structure includes a door to allow access to the shelves when open and to completely enclose the shelves and their contents when closed. For purposes of describing the claimed invention, a dispensing apparatus for dispensing horse feed will be described in detail as an example, but the invention is not so limited. Horse feed can include flakes of hay or alfalfa, feed pellets, grain, etc.

Each shelf is contemplated to hold a portion of feed to be dispensed at a predetermined time. Each shelf is controlled by a separate actuator that is separately communicates with a programmable electronic controller. Each actuator is relatively simple in operation, and exposed moving parts are minimal. All of the actuators and associated wiring is separated from the material to be dispensed such that there is practically no possibility of material interfering with the actuator mechanisms or shelf movement. Each shelf also includes an electronic sensor that senses whether the shelf is in a first “up” or “undispensed” position, or in a second “down” or “dispensed” position. Each sensor communicates the position of a respective shelf to the controller.

The controller is programmable to dispense from particular shelves at programmed times. The controller displays status information including battery life indication, position of each shelf, current programmed dispensing times, etc. The controller displays various error or alert messages, such as an indication that a shelf is in an incorrect position, the battery is low, or that a programming time that is being entered is not allowed (for example because a prescribed order in which the shelves should be dispensed from would be violated). The controller optionally includes audible alarms for communicating various conditions.

In various configurations, the controller includes wireless communications interfaces for allowing the controller to communicate with a mobile communications device such as a cellular phone or radio frequency (RF) device both for receiving programming and for transmitting status and error/alert information.

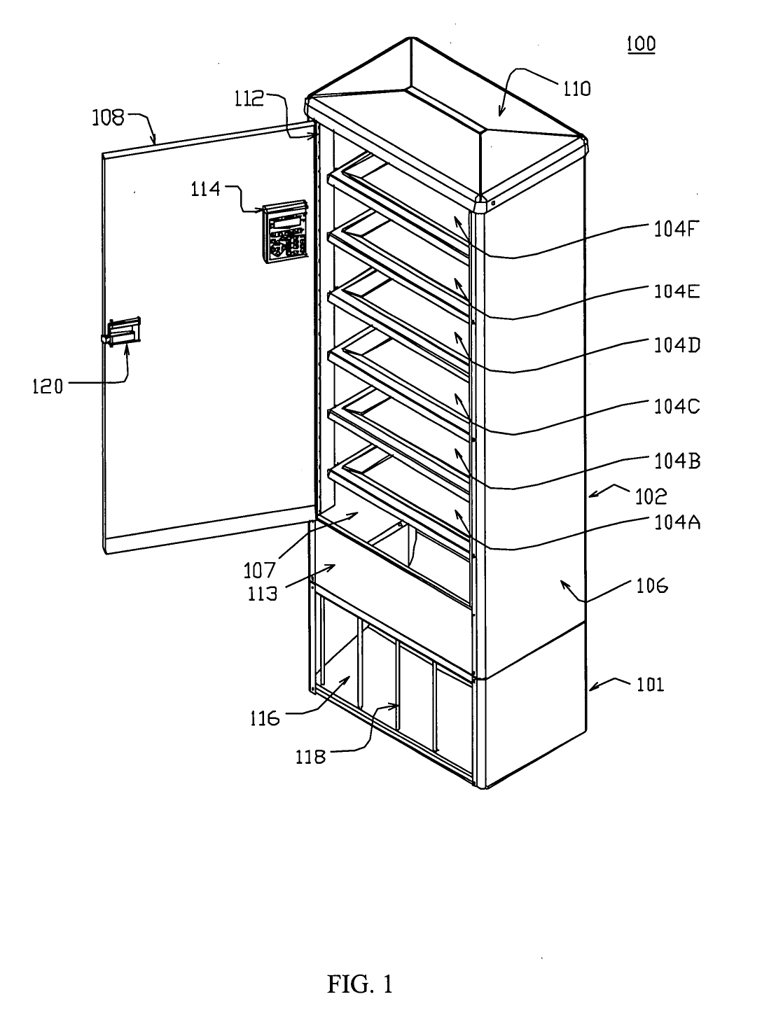

FIG. 1 is a view of a dispenser assembly 100 looking slightly down toward the right side and the front. The assembly 100 includes a storage and dispensing unit 102 and a base chute unit 101. As further explained below, the base unit 101 may be optionally omitted in some installations.

The storage and dispensing unit 102 includes a left side panel 107, a right side panel 106 and a back panel (not visible in this view). The left side panel 107 and the right side panel 106 are each connected to the back panel. The left side panel 107, the right side panel 106 and the back panel are further connected to a top bulkhead (shown and described further below). The top bulkhead is covered by a top 110 that protects the assembly 100 and its contents from the elements.

A kick panel 113 is connected to the left side panel 107 and the right side panel 106. The kick panel 113 adds stability to the vertical structure formed by the left side panel 107, the right side panel 106 and the back panel, especially in installations that omit the base chute unit 101.

A door 108 is connected to a door hinge 112. The door 108 is optional, but is desirable in most applications to protect feed from the elements and other creatures, such as birds. The door 108 includes a door latch 120 that optionally includes a lock to prevent the assembly or its contents from being interfered with or stolen.

The vertical structure formed by the left side panel 107, the right side panel 106 and the back panel encloses shelves 104. In an embodiment, there are six shelves 104A, 104B, 104C, 104D, 104E, and 104F. However, the invention is not so limited and more or fewer shelves 104 could be used. Each shelf 104 is contemplated to contain a portion of feed to be dispensed at one time.

The shelves 104 are each separately manipulated by a respective actuator (not shown here, but shown in later figures). The shelves 104 are shown in a first position referred to herein as the “up” position. When feed is dispensed from a shelf 104 it is released from the up position to a second, “down” position that allows any feed on the shelf 104 to fall down through the open bottom of the storage and dispensing unit 102. A mechanism retaining one shelf 104 in the up position and causing the shelf 104 to transition from the first position to the second position is illustrated and explained further below.

The actuators for all of the shelves 104 are each separately controlled by a programmable electronic controller 114. The electronic controller 114 is explained further below.

The base chute unit 101 includes a chute ramp 116 and grate bars 118. The chute ramp 116 guides dispensed feed to the outside of the base chute unit 101. The chute ramp 116 is optional and is eliminated in some installations. Grate bars 118 are also optional, and are removable, as described further below, to allow the horse easier access to the dispensed feed.

The assembly 100 is contemplated to be supplied to the user as two separate pieces: the storage and dispensing unit 102 and the base chute unit 101. The storage and dispensing unit 102 may be used separately if desired. In such an embodiment, the storage and dispensing unit 102 is secured to a fence or wall within an area accessible to the animals to be fed. For convenience herein the animal to be fed will be referred to as the horse, but the invention is not so limited.

Feed that is dispensed falls from the bottom of the storage and dispensing unit 102 directly to the ground or into or onto anything placed directly below the storage and dispensing unit 102. The storage and dispensing unit 102 is secured to the fence or wall with the door 108 facing out and accessible to the user. In some installations, the door 108 faces the area accessible to the horse, while in other installations, the door 108 faces away from, and is not within the area accessible to the horse.

In applications in which both the storage and dispensing unit 102 and the base chute unit 101 are used, the unit 101 and the unit 102 are easily assembled by screwing the two units together as illustrated further herein. This is the only assembly required of the user. The user may assemble the unit 101 and the unit 102 together as shown in FIG. 1 such that the chute ramp 116 and the grate bars 118 face the door 108. Alternatively, the base unit 101 is rotated 180 degrees such that the chute ramp 116 and the grate bars 118 face away from the door 108. This allows the door 108 to be inside an area accessible to the horse or outside an area accessible to the horse.

In various embodiments, the assembly 100 is placed in its location of use and secured. For example, the assembly 100 as shown in FIG. 1 may be placed inside a corral with the back side facing the corral fence. The assembly 100 is secured to the corral fence. The user enters the corral to load and program the assembly 100 and the horse feed from the bottom of the unit by pulling out feed that has been dispensed down the chute ramp 116. The grate bars 118 are optional, and can be removed in other embodiments to allow dispensed feed to fall further out of the base chute unit 101.

In other embodiments, the assembly 100 is assembled with the base chute unit 101 rotated as previously described. In such an embodiment, the assembly 100 is placed against and secured to the outside of a corral fence, for example. This allows the user to access the door 108 from the outside of the corral, while the horse has no access to the door 108 or the bulk of the assembly 100, but can access the feed dispensed from the assembly 100.

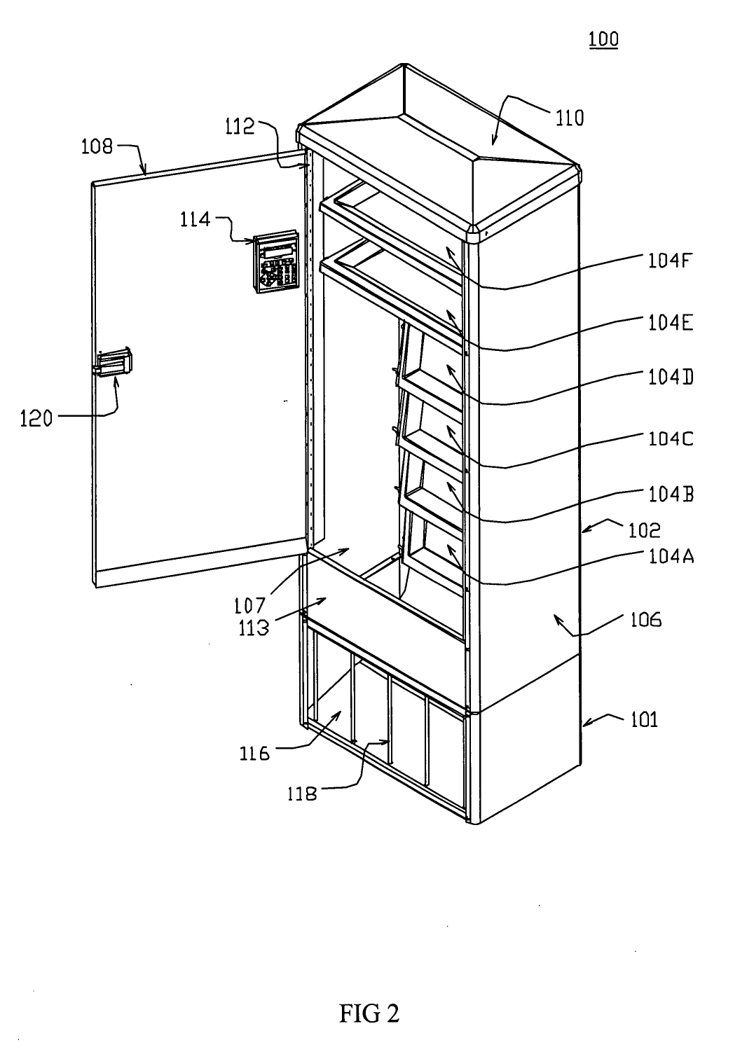

FIG. 2 is view of a dispenser assembly 100 showing shelves 104A, 104B, 104C, 104D in the down position. In the configuration of FIG. 2, four different dispensing events have occurred. First, shelf 104A transitioned from the up position to the down position, dispensing its feed, next shelf 104B transitioned from the up position to the down position, next shelf 104C transitioned from the up position to the down position, next shelf 104D transitioned from the up position to the down position.

In an embodiment, a shelf 104 should not transition from the up position to the down position (also referred to as being dropped) unless it is the lowest shelf 104 currently in the up position. This is to prevent a shelf 104 falling onto a lower shelf that is in the up position.

In an embodiment, the controller 114 at all times senses the current position of each of the shelves 104. As further shown and described below, the user enters (programs) desired feeding times into the controller 114. When a programmed feeding time occurs, the controller drops the lowest shelf in the up position. The controller senses and displays multiple errors to make the user aware of conditions that require human attention. For example, when the operating voltage drops to 10 volts or less, a “battery low” indication is displayed. In addition, when the controller attempts to drop a shelf, and the shelf does not drop, a corresponding error indication is displayed. Further, when a user programs multiple feeding times, but there are not enough shelves in the up position to complete the programmed feedings, the controller displays a “failed to feed” message that includes the time of the first failed feeding event. This situation may occur when the user does not return to the feeder to reload the shelves as planned before a programmed feeding event.

In order to reload a shelf that has been dropped, the user merely lifts the shelf into the up position. As shown and explained further below, the shelf automatically latches into the up position and is prevented from being lifted too far past the up position by over-travel stops. In an embodiment, the shelves are fabricated from plastic that is substantial enough to maintain its shape under use, yet much lighter than other materials such as some metals. Therefore, reloading the shelves is easily accomplished even by a relatively small or young user.

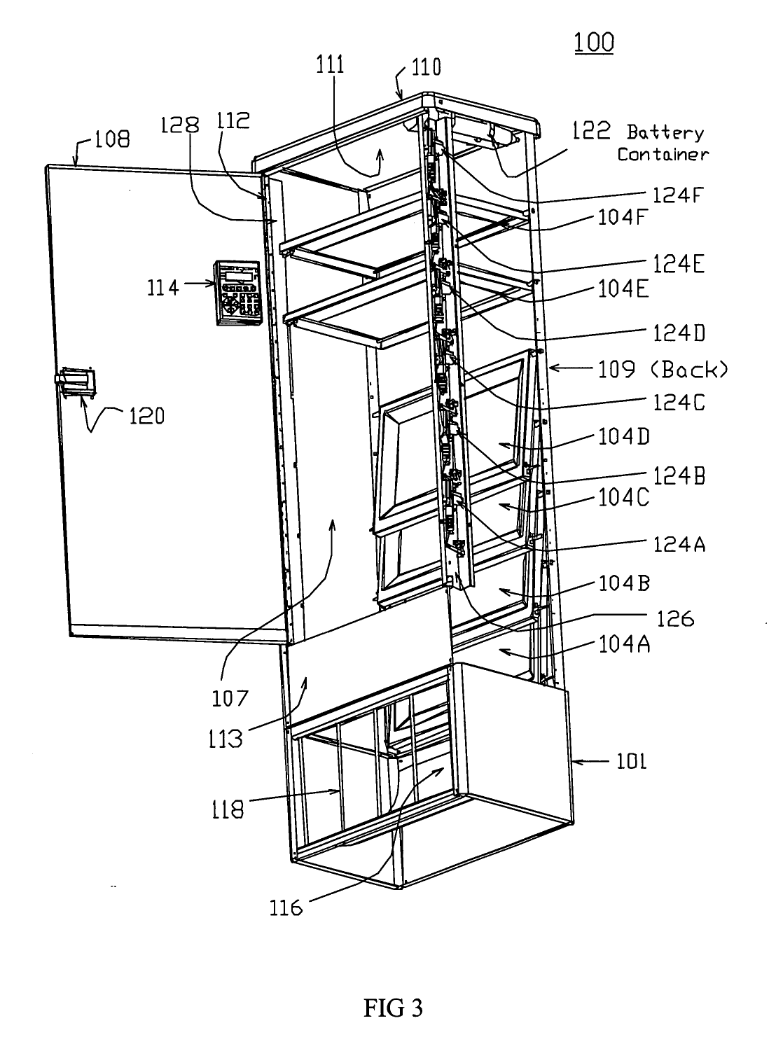

FIG. 3 is a view of a dispenser assembly 100 looking slightly upward toward the right side and the front. In this view, the right side panel 106 is removed to show other components. A top bulkhead 111 is shown below the top 110. The top bulkhead 111 is connected to the left side panel 107, a back panel 109 and the right side panel 106 (not shown). The top 110 is then connected to the top bulkhead 111. In an embodiment, the top bulkhead 111, the back panel 109 and the right side panel 106 are each fabricated of sheet metal, while the top 110 is fabricated of plastic, but embodiments are not so limited.

Two battery containers 122 are removably coupled to the top bulkhead 111. In other embodiments, more or fewer battery containers 122 can be used. In an embodiment, the battery containers 122 are snapped into clips that are connected to the top bulkhead 111. In an embodiment, each battery container 122 holds four “D” cell batteries, but embodiments are not so limited.

An actuator channel 126 is connected to the right side panel 106 (not shown) and accommodates actuators 124. Each of actuators 124A, 124B, 124C, 124D, 124E, and 124F manipulate a respective, similarly designated shelf 104. For example, actuator 124A manipulates shelf 104A, and so on. The actuators 124 are connected to a side of the actuator channel 126 away from the shelves 104 and the interior of the vertical structure formed by the left side panel 107, the back panel 109, and the right side panel 106 (not shown). Each actuator 124 is wired to the batteries in the battery containers 122 and to the controller 114 through the actuator channel 126 and by the top bulkhead 111 so as to keep all wiring clear of the interior of the vertical structure.

A hinge channel 128 is connected to the left side panel 107. The hinge 112 is connected to the hinge channel 128 and to the door 108.

The kick panel 113 is connected to the left side panel 107 and to the right side panel 106 (not shown). In the view of FIG. 3 it can be seen that the bottom of the vertical structure is open, allowing dispensed feed to fall downward through the opening at the bottom. Similarly, the bottom of the base chute unit 101 is open. In other embodiments, a bottom panel can be connected to the bottom of the base chute unit 101 if desired.

In an embodiment, shelf 104A, in the down position is proximate the bottom edge of the bottom of the back panel 109, but does not obtrude from the bottom of the vertical structure. In other embodiments, such as for installations that secure the vertical structure on a surface some distance from the floor or ground, the shelf 104 may obtrude from the bottom of the vertical structure in the down position.

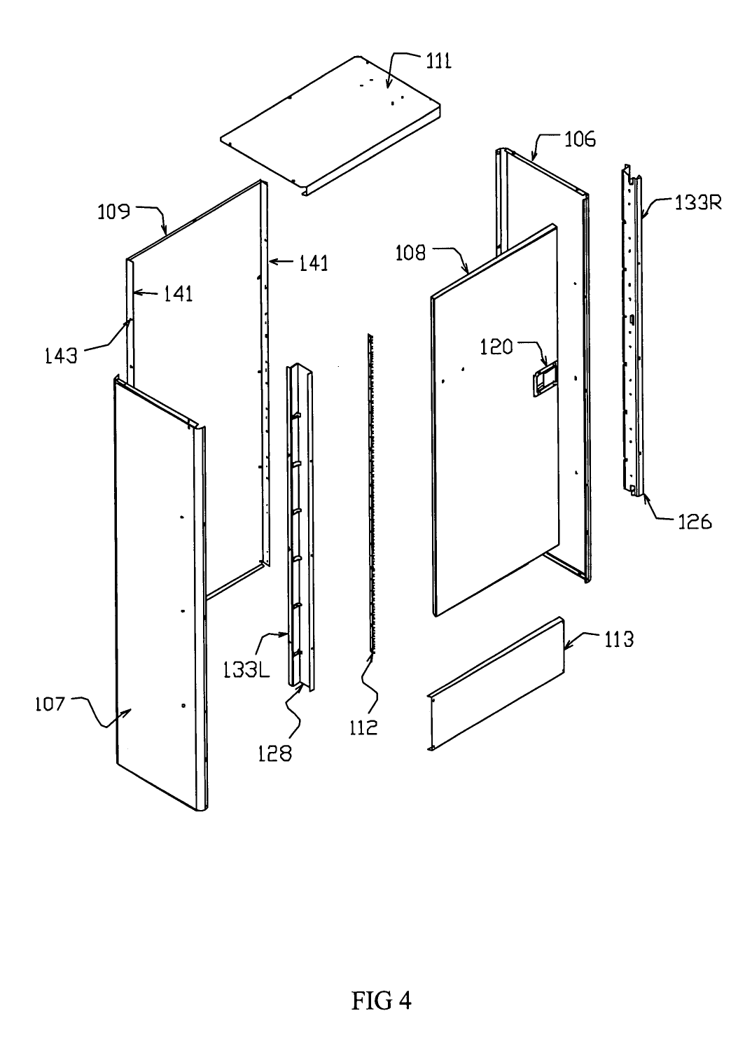

FIG. 4 is an exploded view of the assembly 100 showing a subset of its components. In an embodiment, the components shown are the main sheet metal components of the vertical structure. The left side panel 107 is shown. In an embodiment, the left side panel 107 is bent along its edges to provide fastening surfaces to mate with the back panel 109, the top bulkhead 111, and the hinge channel 128. A bottom fastening surface allows mating of the left side 107 with the base chute unit 101.

The back panel 109 is bent to provide two vertical shelf rod flanges 141. Each of the shelf rod flanges 141 includes multiple shelf rod holes 143 (only one of which is designated for clarity). Each of the shelf rod holes 143 accommodates an end of a shelf rod (later shown and described) which allows a shelf to rotate from the up position to the down position.

The back panel 109 is further bent to provide fastening surfaces to mate with the top bulkhead 111. A bottom fastening surface allows mating of the back panel 109 with the base chute unit 101.

The right side panel 106 is bent along its edges to provide fastening surfaces to mate with the back panel 109, the top bulkhead 111, and the actuator channel 126. A bottom fastening surface allows mating of the right side 106 with the base chute unit 101.

The actuator channel 126 includes multiple trip rod latch slots 133R (only one of which is designated for clarity). Each of the trip rod latch slots accommodates a trip rod latch (later shown and described) that rests in the trip rod latch slot 133R to retain a corresponding shelf 104 in the up position.

In an embodiment, the hinge channel similarly includes multiple trip rod latch slots 133L (only one of which is designated for clarity). Each of the trip rod latch slots 133L corresponds to a trip rod latch slot 133R. The trip rod latch slot 133L accommodates a trip rod latch (later shown and described) that rests in the trip rod latch slot to retain a corresponding shelf 104 in the up position. In such an embodiment, each shelf has two corresponding trip rod latches, one latching in slot 133L and one latching in slot 133R. In other embodiments, however, each shelf could include only one trip rod latch for latching in slot 133R, for example.

The door 108 and the door latch 120 are also shown. In an embodiment, the edges of the door 108 are bent inward to provide a mating surface on the left vertical edge with the hinge 112 and further to avoid exposing any sharp edges to the horse or to the user. The door latch 120 includes a latch mechanism which mates with a latch hole in the actuator channel (not shown). The door latch 120 further includes a handle for manipulating the latch mechanism. The door latch 120 optionally includes a lock mechanism.

In an embodiment, the edges of the kick panel 113 are bent inward to provide a mating surface on the bottom horizontal edge with the base chute unit 101 (not shown) and further to avoid exposing any sharp edges to the horse or to the user.

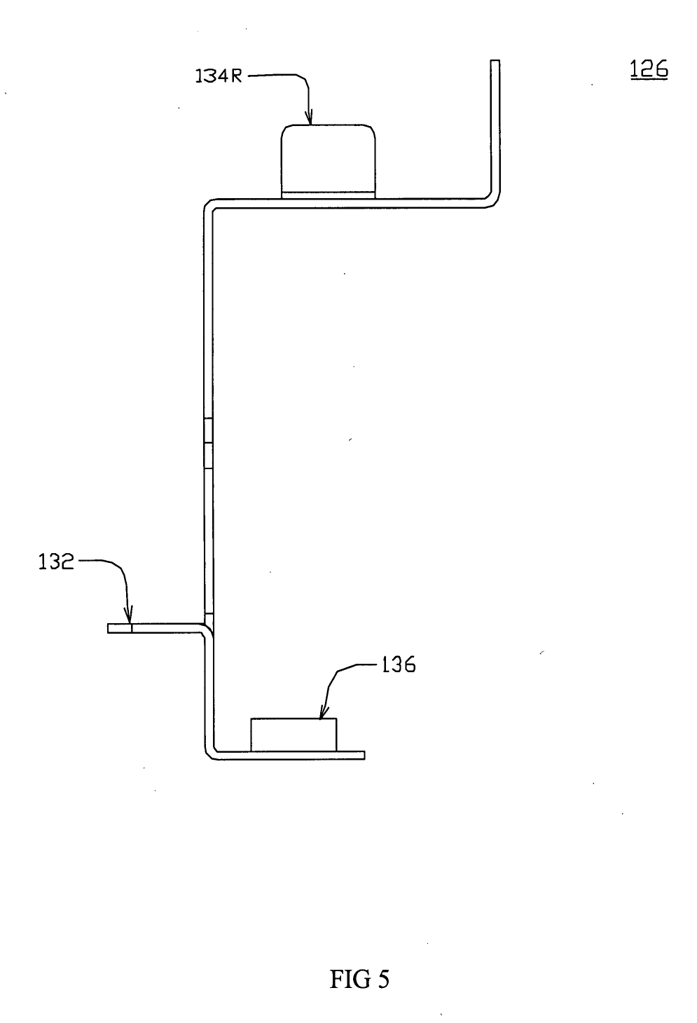

FIG. 5 is a cross-section of the actuator channel 126 in an embodiment. The actuator channel includes multiple shelf over-travel stops 134R. Only one stop 134R is shown. In an embodiment, each stop 134R is created by bending up the tab-like stop, which also forms a trip rod latch slot 133R (not shown in this view) in the actuator channel 126. As previously described, after a shelf has been dropped, the user easily returns the shelf to the up position by lifting it until the trip rod latch(es) latch into the trip rod slot(s) 133. The over-travel stops 134R prevent inadvertent lifting of the shelf past the horizontal up position.

The actuator channel also includes one or more door stops 132 formed by bending out the tab-like stop. The door stop(s) 132 prevent the door from moving past a proper closed position into the interior of the vertical structure. A nut insert 136 is an example of several such inserts that are used to secure components to the actuator channel 126.

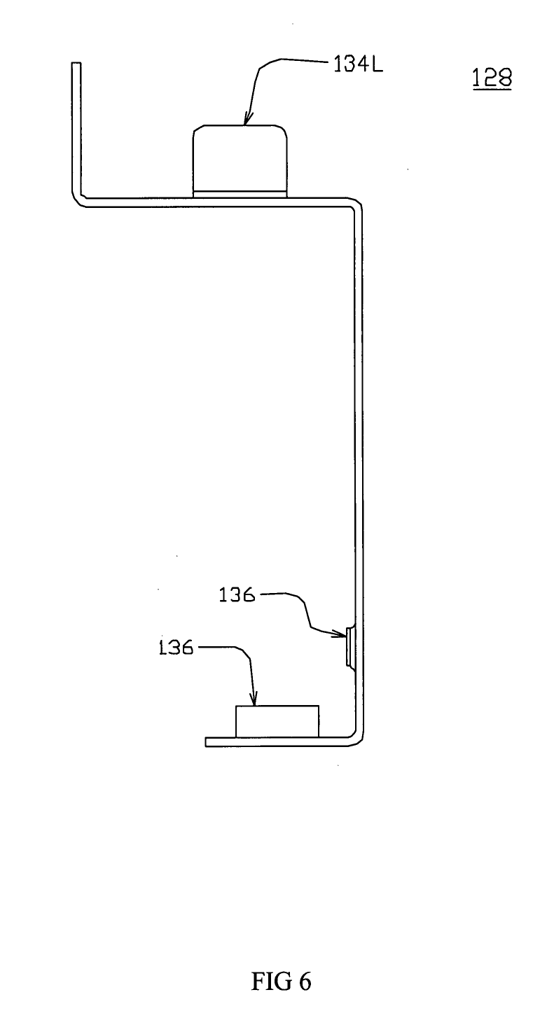

FIG. 6 is a cross-section of the hinge channel 128 in an embodiment. The hinge channel includes multiple shelf over-travel stops 134L. Only one stop 134L is shown. In an embodiment, each stop 134L is created by bending up the tab-like stop, which also forms a trip rod latch slot 133L (not shown in this view) in the hinge channel 128. As previously described, after a shelf has been dropped, the user easily returns the shelf to the up position by lifting it until the trip rod latch(es) latch into the trip rod slot(s) 133. The over-travel stops 134L, along with the over-travel stops 134R, prevent inadvertent lifting of the shelf past the horizontal up position. The hinge channel 128 also includes multiple nut inserts 136 that are used to secure components to the actuator channel 128, such as the hinge 112, for example.

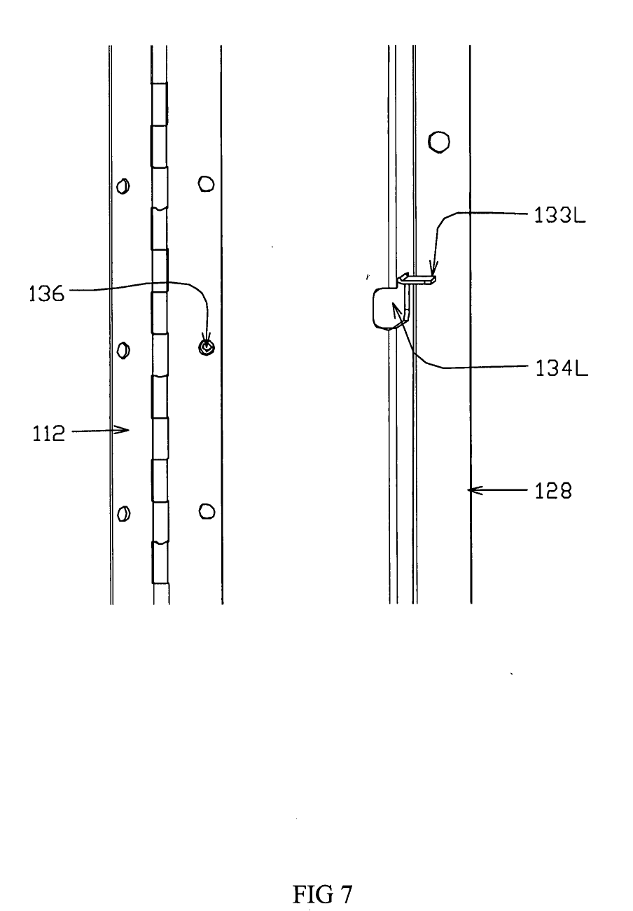

FIG. 7 is a view of the hinge channel 128 and the hinge 112. A trip rod latch slot 133L is shown along with a corresponding over-travel stop 134L. It can be seen that the trip rod latch slot 133L is formed in the hinge channel 128 by removing material from two surfaces of the hinge channel 128 that are each in different planes. The material removed from one of the planes is used as the over-travel stop 134L. This plane is also the plane of a trip rod latch when it is entering the slot 133L, as shown further below. The trip rod latch enters the slot 133L by passing below the over-travel stop 134L and then latches by resting in the slot 133L.

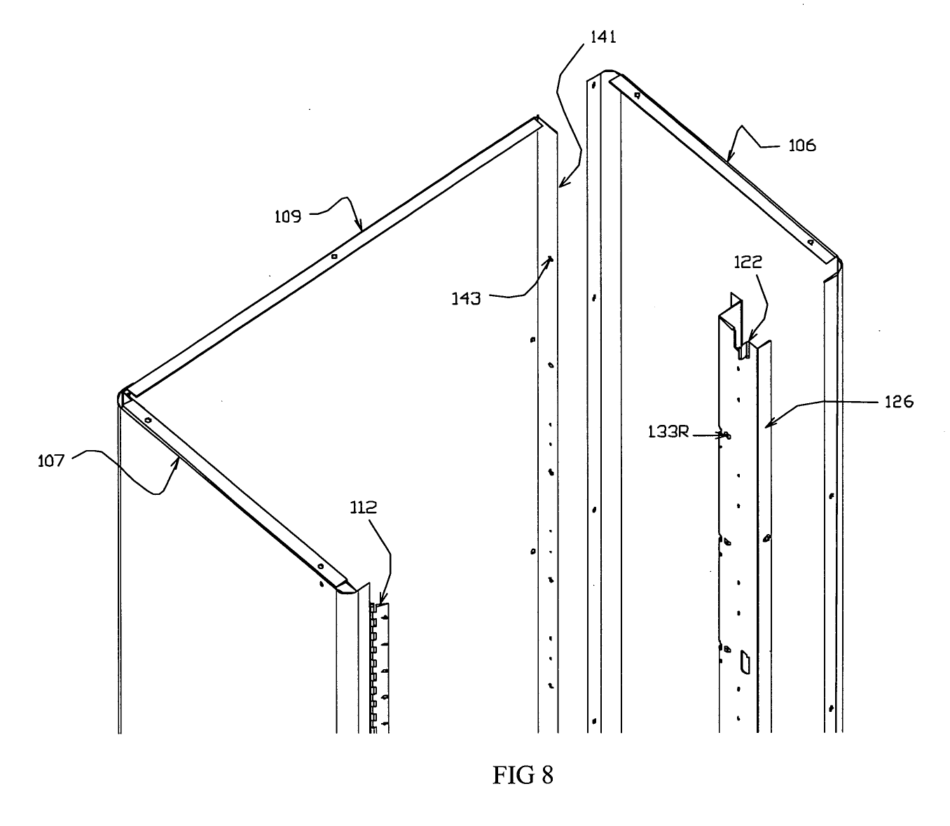

FIG. 8 is a view showing more detail of various components, including the left side panel 107, the back panel 109, the right side panel 106, and the actuator channel 126. Bent top areas of the left side panel 107, the back panel 109, and the right side panel 106 are shown with holes for connecting to the bulkhead 111 (not shown). One shelf rod flange 141 is shown detached from right side panel 106. One of the shelf rod holes 143 is designated, although the number of shelf rod holes in one flange 141 is equal to the number of shelves 104.

A door stop 132 is shown on the actuator channel 126. One trip rod latch slot 133R is designated, although the number of trip rod latch slots 133R is equal to the number of shelves 104.

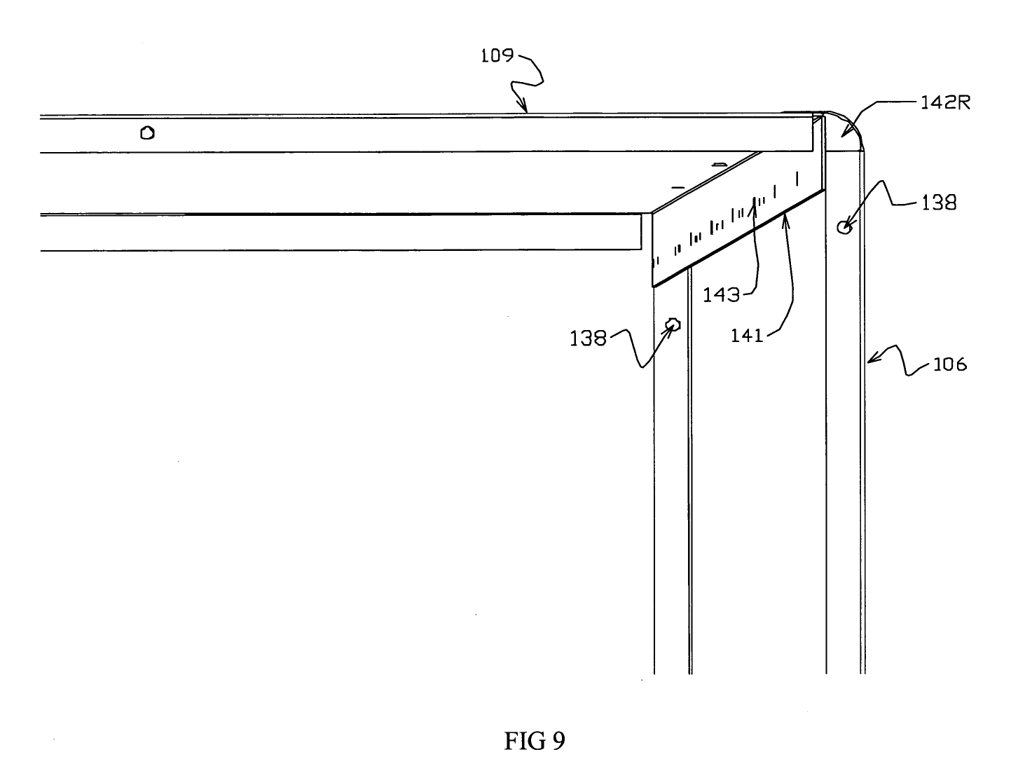

FIG. 9 is a view showing more detail of the back panel 109 and the right side panel 106. The shelf rod flange 141 abuts the bent top area of the right side panel 106, which causes an area 140R to be open to accommodate shelf rods (not shown) that are inserted into shelf rod holes 143. Connector holes 138 are shown located in top bent area and bottom bent areas of the right side panel 106. The designated connector holes 138 are for connecting the right side panel 106 to the top bulkhead 111 and to the base chute unit 101. However, other multiple connector holes 138 that exist in various different components are not specifically designated for clarity.

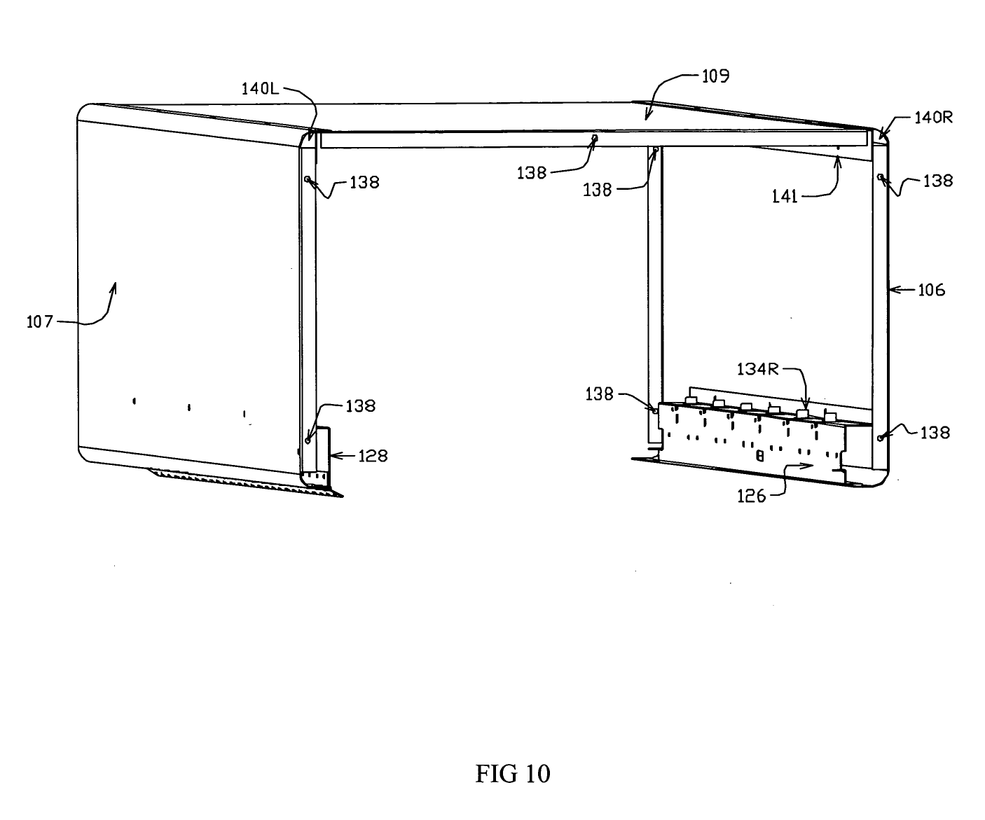

FIG. 10 is a view showing left side panel 107, back panel 109, right side panel 106, hinge channel 128, and actuator channel 126. In this view, two areas 140, and area 140L and an area 140R are visible. Areas 140 accommodate the ends of shelf rods (later shown) that are coupled to each shelf. Each shelf rotates about a shelf rod between the up position and the down position when the shelf rod ends are inserted in the shelf rod holes of the shelf rod flanges 141.

Six over-travel stops 134R are evident. There is one over-travel stop 134R for each shelf, and below each over travel stop 134R is a corresponding trip rod latch slot 133R (not shown in this view). In other embodiments there could be more than six or fewer than six shelves.

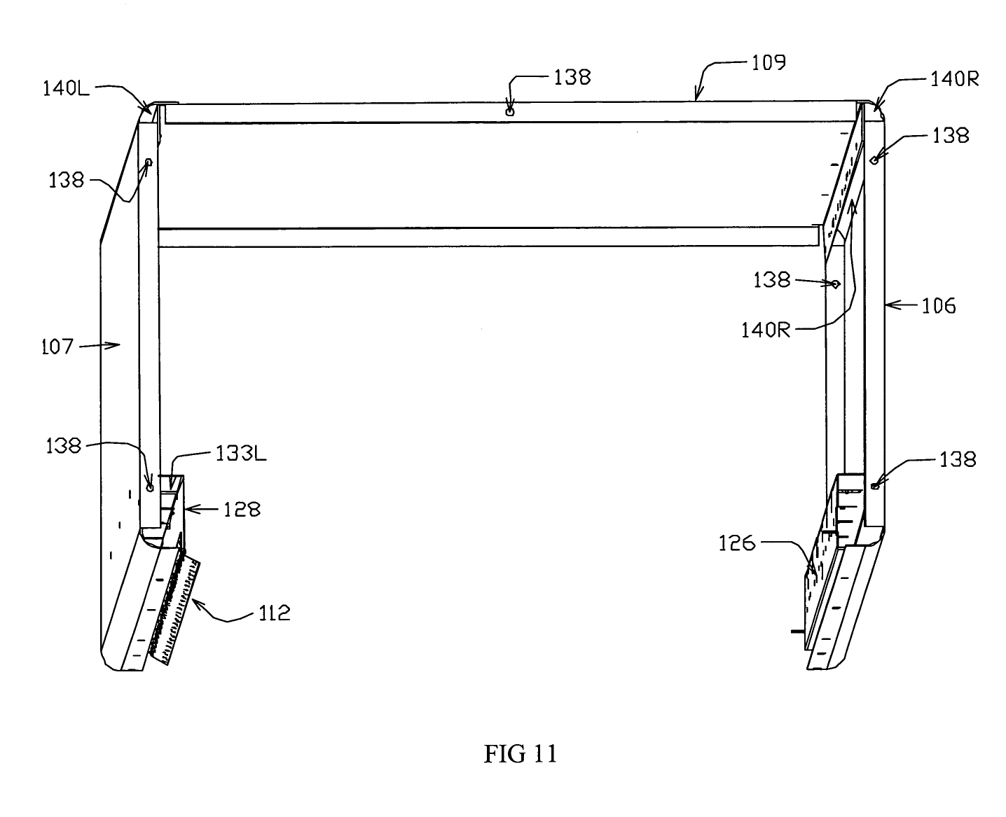

FIG. 11 is another view showing left side panel 107, back panel 109, right side panel 106, hinge channel 128, and actuator channel 126. Areas 140R and 140L are visible. Hinge 112 is shown connected to hinge channel 128. Several of trip rod latch slots 133L are also shown.

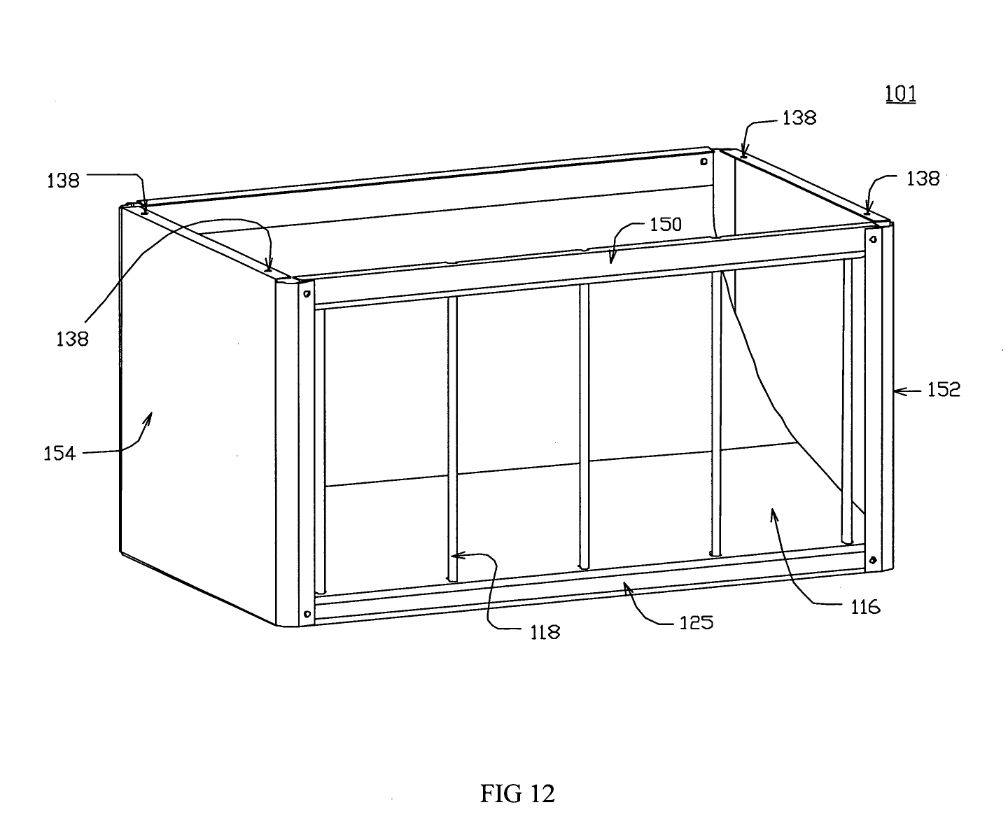

FIG. 12 is a view of base chute unit 101. Base unit 101 includes a left side panel 154 and a right side panel 152. Base unit 101 further includes the chute ramp 116 and grate bars 118. The chute ramp 116 includes holes in its surface through which grate bars 118 protrude. In an embodiment, the chute ramp 116 further includes a bent bottom cross piece 125. Base unit 101 further includes a top cross piece 150 connecting left side panel 154 and right side panel 152 at their respective top edges. In an embodiment, top cross piece 150 member is bent to enhance strength and provide accommodation for grate bars 118, as further shown below. Base unit 101 also includes multiple connector holes 138 for receiving connectors such as screws to connect the unit 101 with the storage and dispensing unit 102. As previously stated the base unit 101 may be connected to the storage and dispensing unit 102 in one of two orientations: with the top cross piece 150 coplanar with the door 108, or with the top cross piece 150 coplanar with the back panel 109. Therefore, designations such as “right” and “left” as used herein are not intended to be limiting or to imply that the left side panel 154 must mate to the left side panel 107 or that the right side panel 152 must mate to the left side panel 106.

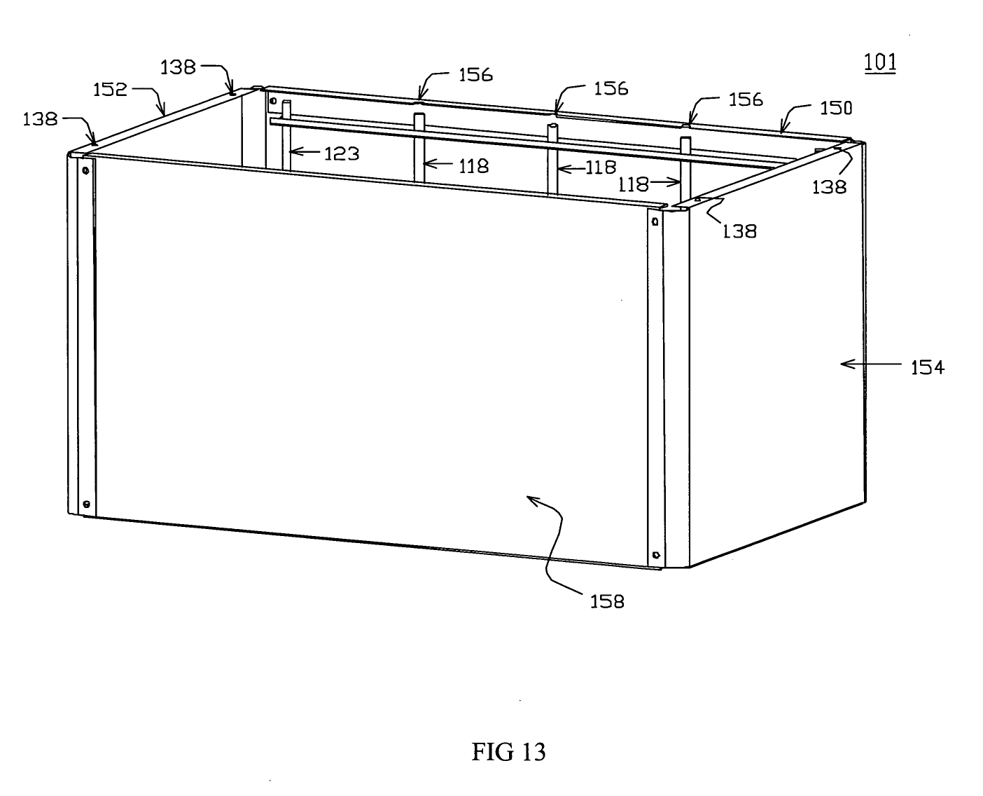

FIG. 13 is another view of base chute unit 101. A back panel 158 connects to the left side panel 154 and to the right side panel 152. Grate bars 118 are removable by extracting them from the chute ramp 116 and the top cross piece 150. The top cross piece 150 includes extraction slots 156 that permit the grate bars 118 to exit chute 101. In an embodiment two grate bars 123 (only one grate bar 123 is visible in this view) are stationary to provide enhanced stability for the base chute 101 and to avoid the possibility of the horse injuring itself on edges of the base chute 101. One grate bar 123 is at the far left of the opening in the base chute 101, and the other grate bar 123 is at the far right of the opening. There are no slots 156 corresponding to the grate bars 123, thus preventing the extraction of the grate bars 123.

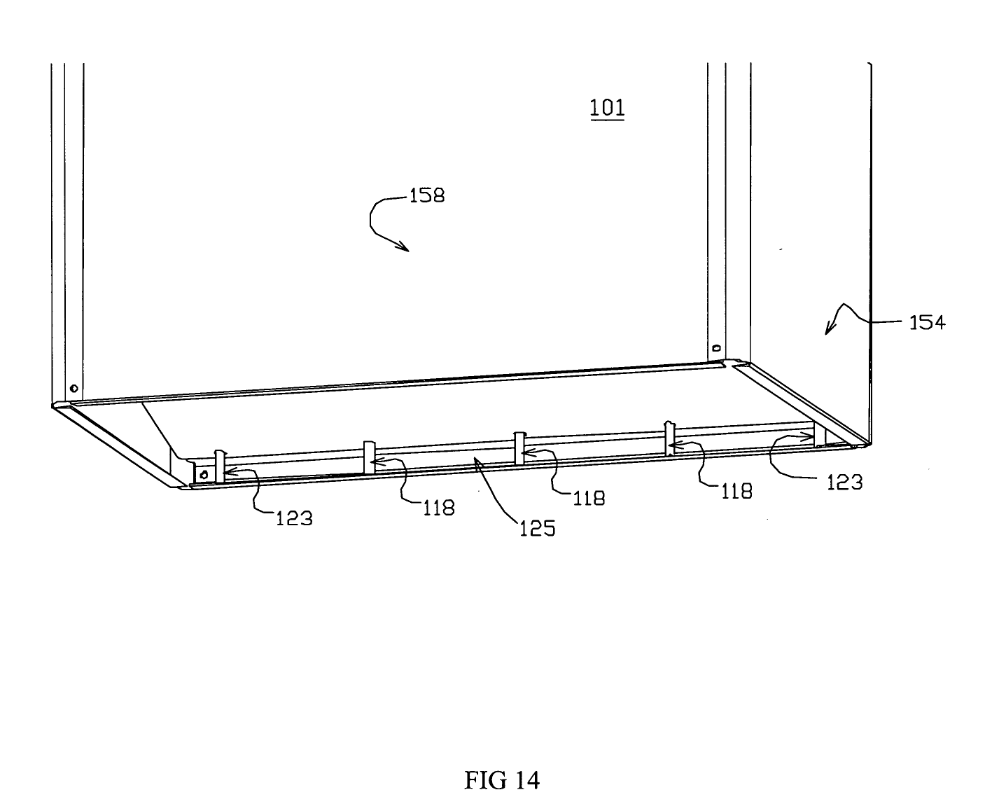

FIG. 14 is a view of the base chute 101 from the bottom. An inside view of the chute ramp 116 is shown showing the holes in its surface through which grate bars 118 protrude. The bottom cross piece 125 includes a bottom portion against which the grate bars 118 and 123 rest when installed in the base chute unit 101.

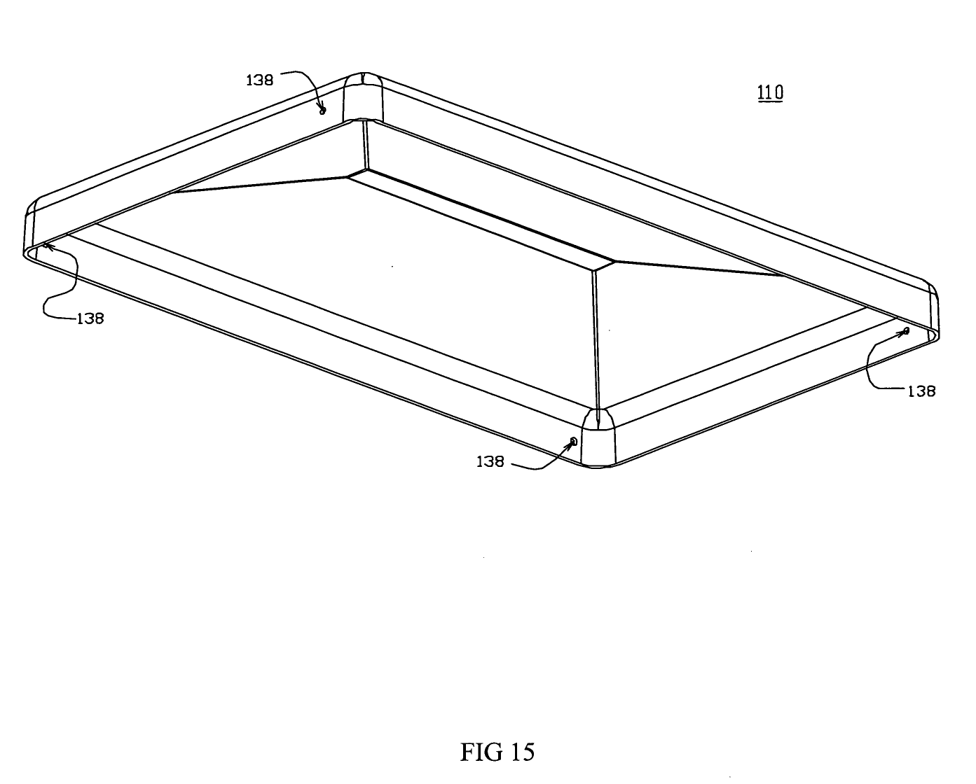

FIG. 15 is a view of the top 110 looking into the interior of the top 110. In an embodiment, the top 110 is convex and shaped to fit over the top bulkhead 111. The convex shape deflects water and debris from the storage and dispensing unit 102. The convex top 110 includes multiple connector holes 138 for assembling the top 110 to the vertical structure including the storage and dispensing unit 102. In an embodiment, the top 110 is formed from plastic, such as by vacuum forming or injection molding. However, in other embodiments the top 110 may be formed from other materials including fiberglass, aluminum and other metals and alloys.

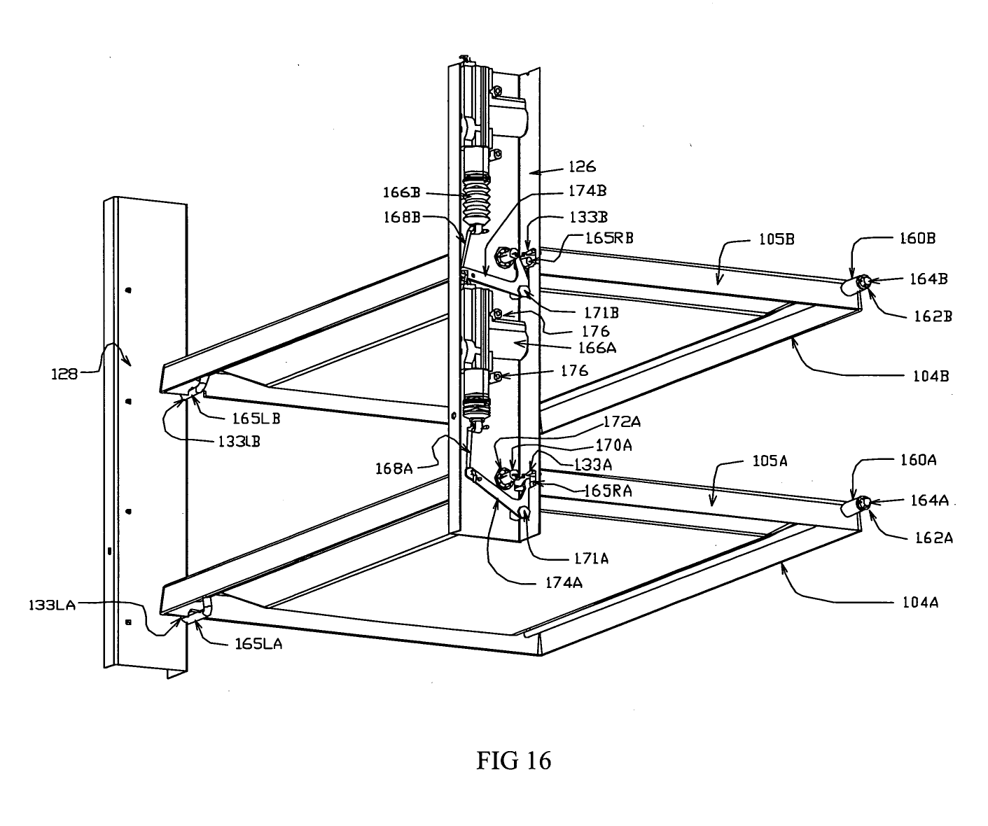

FIG. 16 is view showing further detail of the shelf actuating and retaining mechanisms, according to an embodiment. The hinge channel 128 and the actuator channel 126 are shown. Shelves 104A and 104B are shown. For shelf 104B, a trip rod latch slot 133RB is shown in the actuator channel 126. The shelf 104B is in the up position, so a trip rod latch 165RB is resting in the trip rod latch slot 133RB. Similarly, a trip rod latch 165LB is resting in a trip rod latch slot 133LB of the hinge channel 128. The actuator lever 174B is in close proximity to the trip rod latch 165RB when the shelf 104A is in the up position. The actuator 174B is rotatably coupled to the actuator channel at a pivot point 171B.

In addition, an actuator 166A corresponding to shelf 104A is shown. The actuator 166A is fastened to the actuator channel 126 with screws 176. A link rod 168A is coupled to the actuator 166A, and an actuator lever 174A is attached to the link rod 168A. A magnetic switch 170A is attached to the actuator channel 126 for sensing the position of shelf 104A. The magnetic switch 170A is retained by a switch retainer 172A. In this view, the actuator 166A has been activated, causing the actuator lever 174A to push the trip rod latch 165A out of the slot 133RA. Simultaneously, the trip rod latch 165LA is pushed out of the trip rod latch slot 133LA by rotation of a trip rod (later shown) connecting the trip rod latches 165RA and 165LA.

The shelf 104A includes a circumferential lip 105A. In one embodiment, the shelves 104 are formed plastic. The circumferential lip 105A accommodates two ends of a shelf rod 164A through two holes in the lip 105A. Only one end of the shelf rod 164A is visible. A spacer 160A over the shelf rod 164A maintains space between the lip 105A and the flange 141. A retainer washer is located on the shelf rod 164A on an opposite side of the flange 141 from the shelf 104A so that the shelf rod shelf rod 164A does not fall out of contact with the flange 141. The shelf rod 164A provides a hinge for the shelf 104A, and when the shelf 104A is dropped from the up position to the down position, the shelf 104A rotates about the central axis of the shelf rod 164A.

Similarly numbered elements whose reference numbers are appended with a “B” are shown for shelf 104B, but may not be specifically described for each occurrence. The functions of these similarly numbered elements are similar to those already described, but affect different shelves 104. In later figures, only elements for shelf 104A will be shown and described for conciseness. Each of the shelves 104 not specifically referred to operate as described with reference to shelf 104A and associated elements.

FIG. 16 shows the shelf 104A, the actuator lever 174A, and the trip rod latch 165RA at a point in time when the actuator 166A has just been activated and when the trip rod latch 165RA is just being pushed out of the trip rod latch slot 133RA.

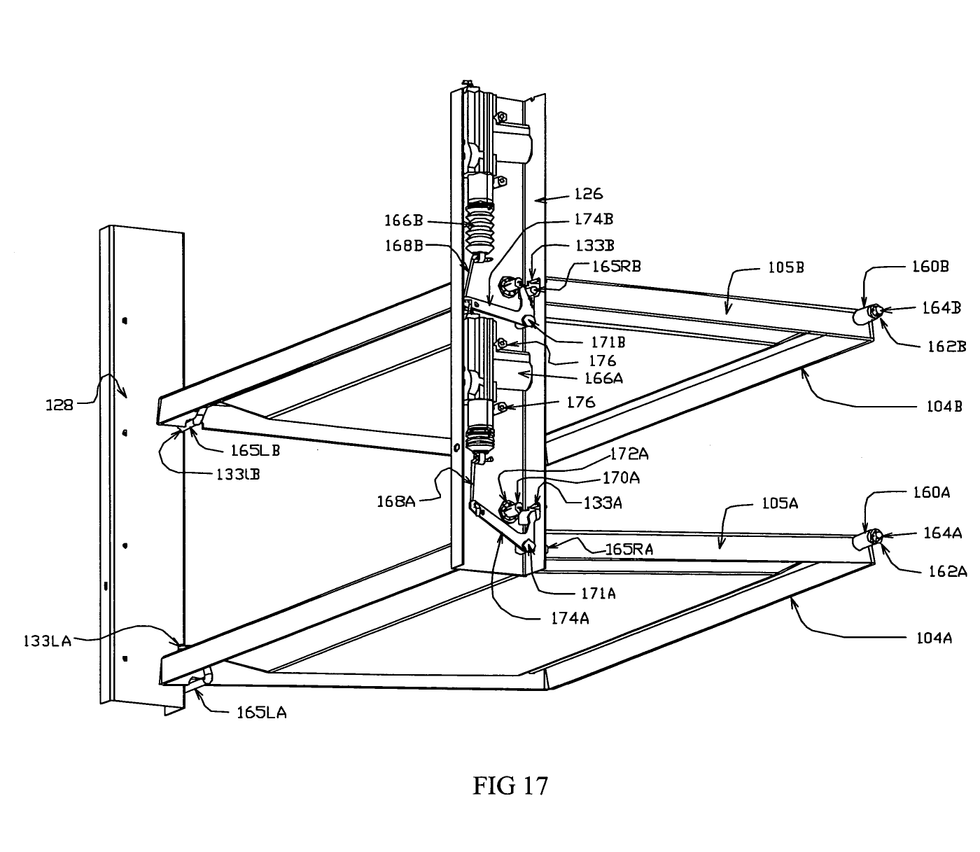

FIG. 17 is a view of the shelf actuating and retaining mechanisms as shown in FIG. 16, but at a later point in time. Elements that were introduced and described earlier will only be described as necessary. In this view, the actuator 166A has been activated, causing the actuator 166A to pull up on the link rod 168A. This in turn causes the actuator lever 174A to pivot about the pivot point 171A and apply pressure to the trip rod latch 165RA. The applied pressure forces the trip rod latch 165RA to be ejected from the trip rod latch slot 133RA. The trip rod latch 165RA is connected to the trip rod latch 165RA by a trip rod (not visible in this view). Therefore, the trip rod latch 165RA is ejected from the trip rod latch slot 165LA simultaneous with the ejection of the trip rod latch 165RA.

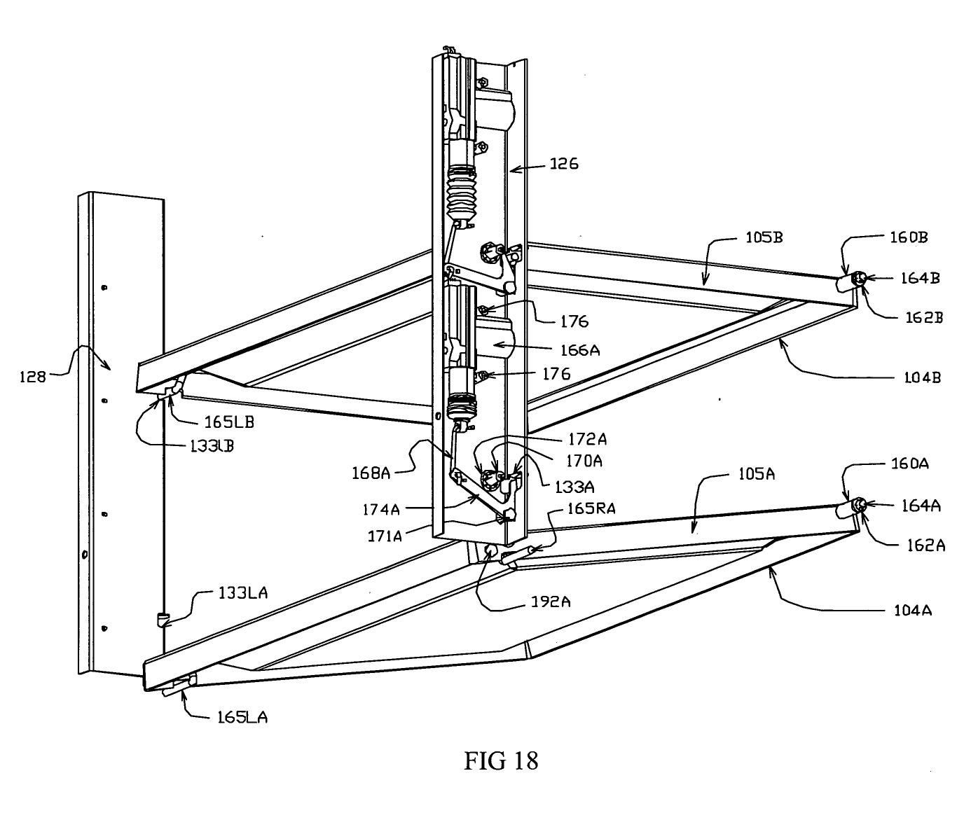

FIG. 18 is another is a view of the shelf actuating and retaining mechanisms as shown in 17, but at a yet later point in time. The shelf 104A is in the process of dropping from the up position to the down position while rotating about the shelf rod 164A. The actuator lever 174A has actually entered the trip rod lever slot 133RA, ensuring that the trip rod latch 165RA is completely ejected. A sensor magnet 192A is shown on the lip 105A. The sensor magnet 192A is electrical contact with the magnetic switch 170A when the shelf 104A is in the up position. However, as soon as the shelf 104A leaves the up position, the sensor magnet 192A is no longer in electrical contact with the magnetic switch 170A. This causes the controller to sense that shelf 104A has been dropped.

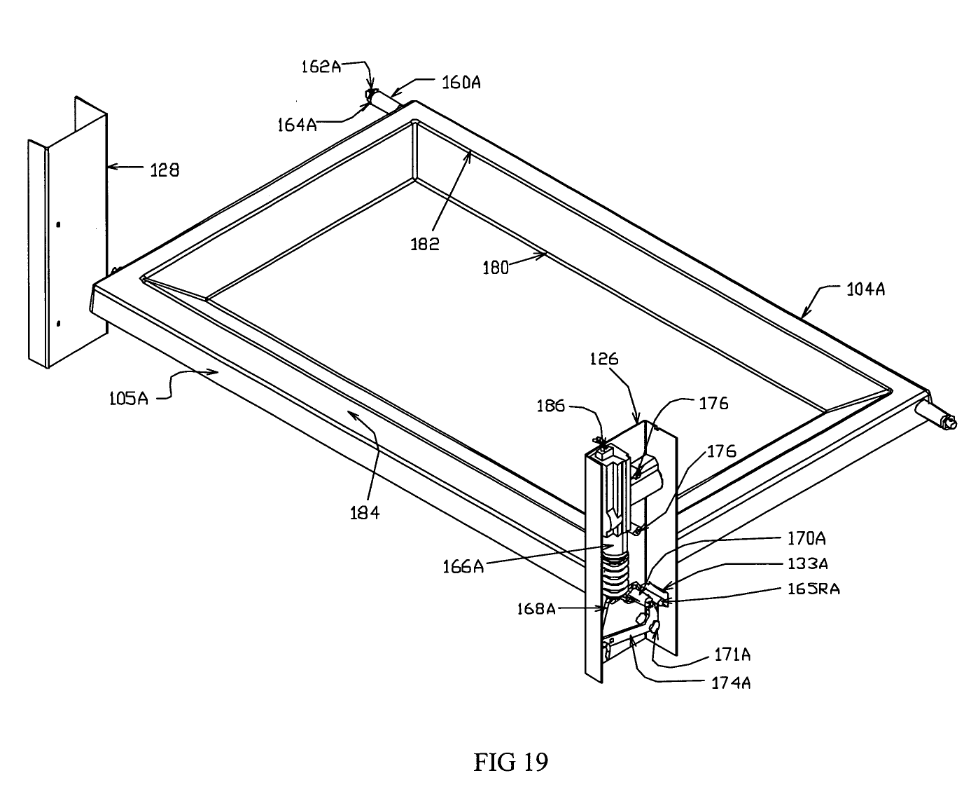

FIG. 19 is another view of the shelf 104A showing a top portion of the shelf 104A. The shelf 104A, in an embodiment, is convex in order to hold feed securely. A bend 180 creates a rectangular bowl area in the center of the shelf 104A. A bend 182 creates a substantially flat circumferential upper edge that defines a horizontal plane when the shelf 104A is in the up position.

Electrical wires 186 provide electricity to the actuator 166A and are part of a circuit that includes the batteries in the battery containers 122 and the controller 114.

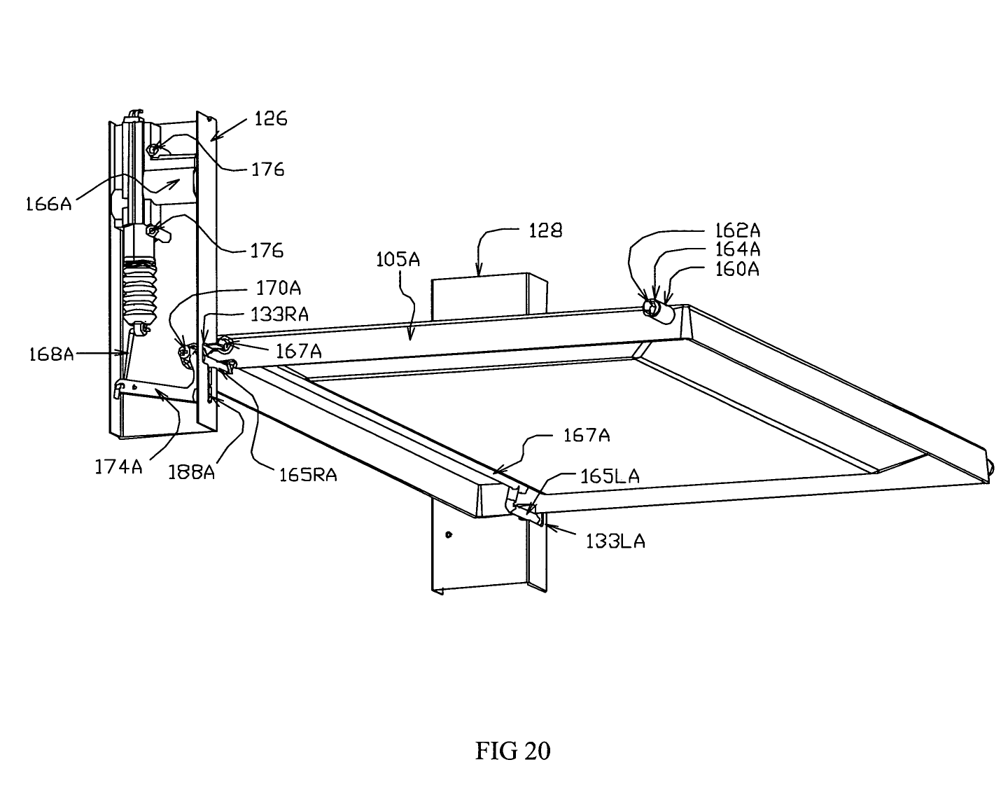

FIG. 20 is another view of the shelf 104A showing a bottom portion of the shelf 104A. A trip rod 167A is visible. Trip rod latches 165RA and 165LA are connected to respective ends of the trip rod 167A. The trip rod 167A is rotatably coupled to the shelf 104A by passing through holes in the lip 105A.

An actuator lever slot 188A in the actuator channel 126 allows the actuator lever 174A to travel through the actuator channel 126 to the extent necessary to completely eject the trip rod latches 165RA and 165LA from their respective trip rod latch slots 133RA and 133LA.

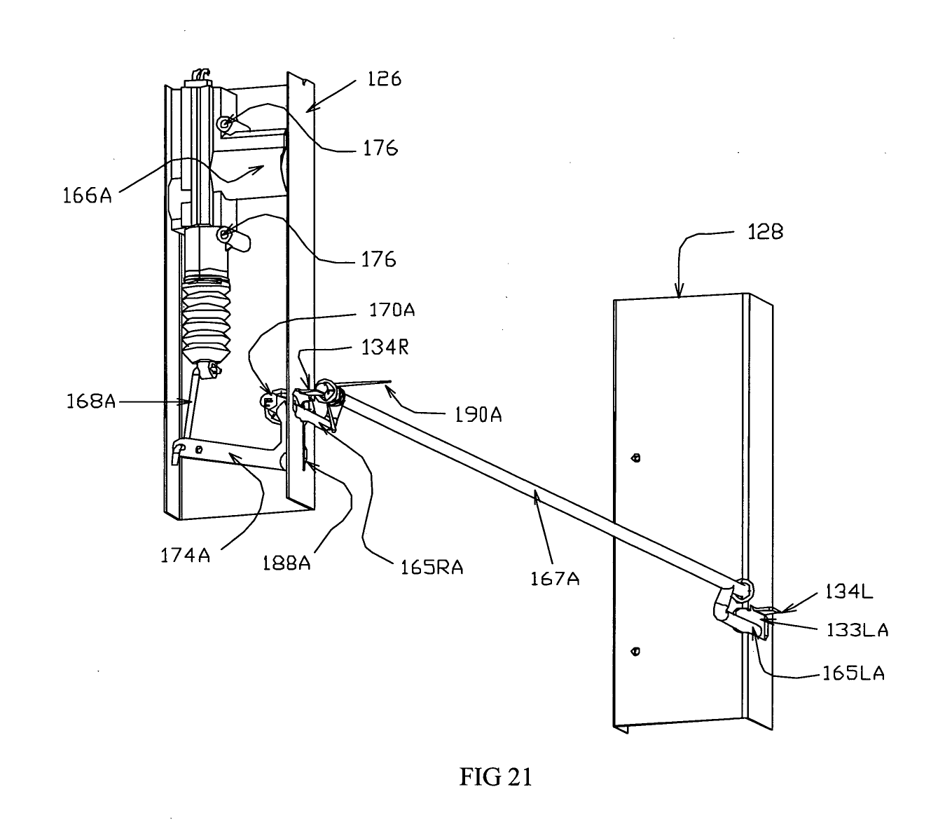

FIG. 21 is a view of various elements of shelf 104A actuating and retaining mechanisms as previously shown, but with the shelf 104A removed for clarity. A torsion spring 190A is wound about the trip rod 167A. An end of the torsion spring 190A is positioned against the shelf 104A (not shown) such that spring tension retains the trip rod latches 165RA and 165LA in the position shown in the figure, also referred to as the latched position. That is, the spring tension exerts torsional pressure on the trip rod so as to rotate the trip rod latches 165RA and 165LA toward the actuator channel 126 and the hinge channel 128. Thus when the shelf 104 is raised, the trip rod latches 165RA and 165LA are pre-loaded to fall into the trip rod latch slots 133RA and 133LA. If the user attempts to raise the shelf 104A beyond the trip rod latch slots 133RA and 133LA, this is prevented by the over-travel stops 134R and 134L. Thus, returning dropped shelves is virtually foolproof. It is very difficult for a careless user to twist or deform the shelves, or cause a shelf to become stuck in an improper position.

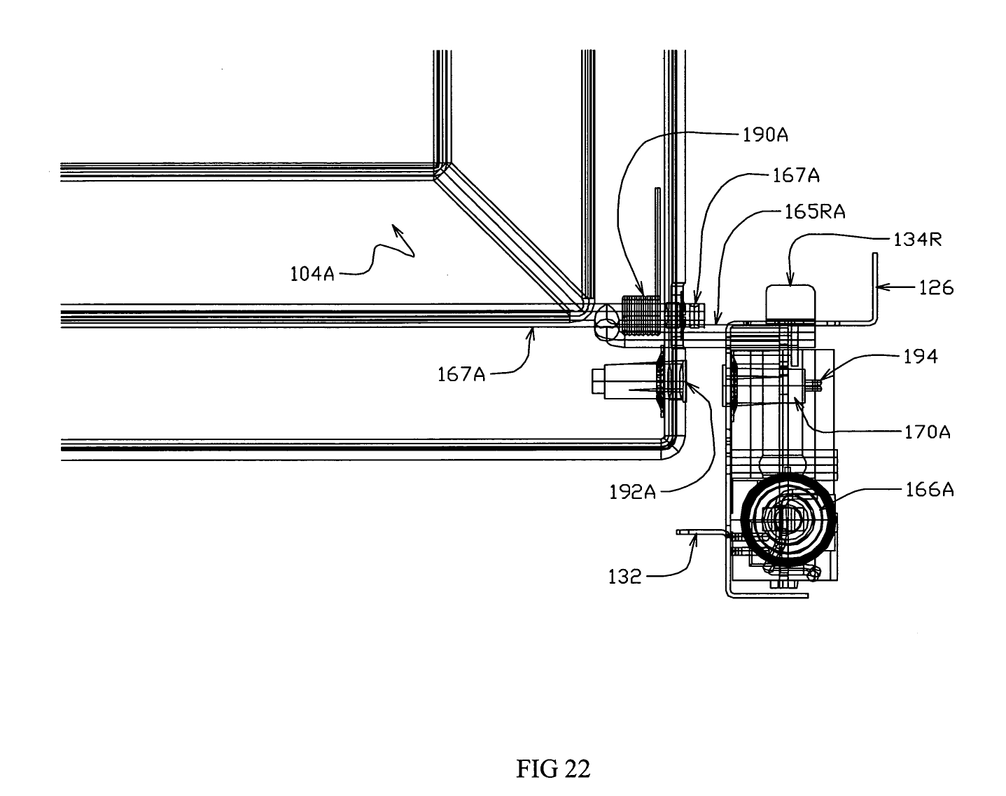

FIG. 22 is plan view of various components, including the actuator 166A in the actuator channel 126, the door stop 132, the sensor magnet 192A, and the over-travel stop 134R. The magnetic switch 170A is connected to switch wires 194, which connect the switch electrically with the circuit including the batteries in the battery containers 122 and the controller 114. Also shown is the trip rod 167A inserted in the shelf 104A, the trip rod latch 165RA and the torsion spring 190A.

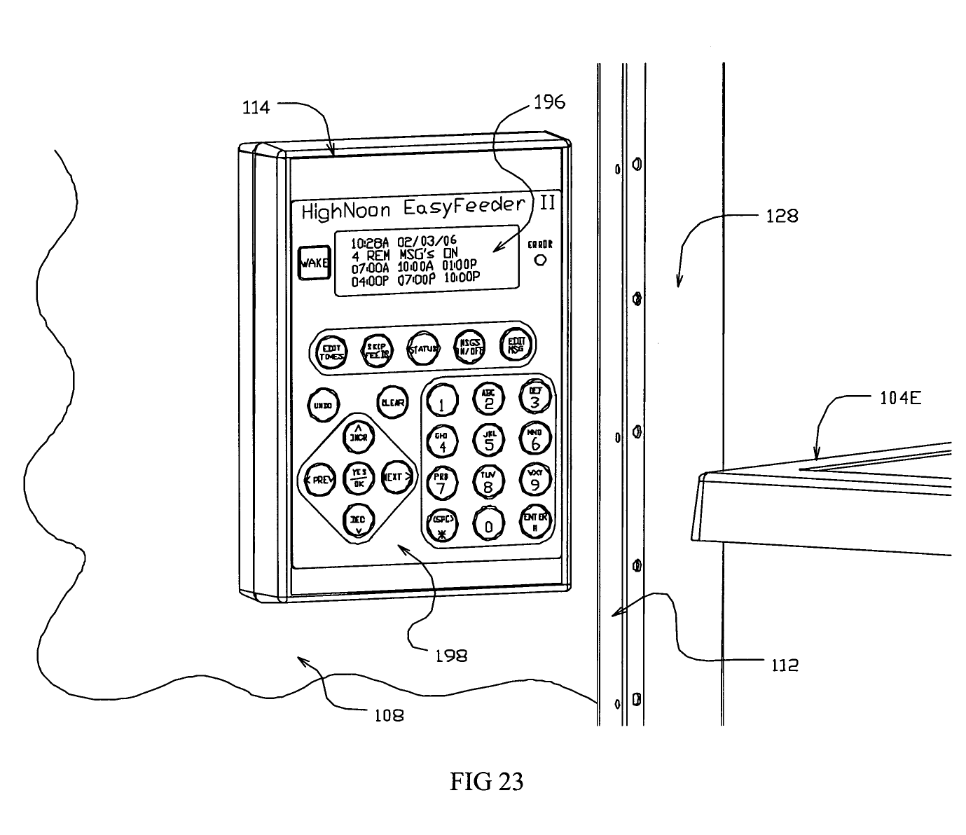

FIG. 23 is a front view of the controller 114 installed on a door 108. The door 108 is assembled to the hinge 112 and to the hinge channel 128. For clarity, many components are not shown. In one embodiment with six shelves, the controller 114 is located at approximately the elevation of shelf 104E, but many other locations are possible.

The controller 114 includes a display 196, which in an embodiment is a liquid crystal display (LCD). The display 196 is configurable to display many types of data and the data shown is just an example. Currently the top line of the display 196 shows the current time and date. The second line shows how many shelves are in the up position, and whether any errors occurred. The bottom two lines show times the shelves are currently programmed to be dropped. A “WAKE” button to the left of the display 196 causes the controller to exit the power-conserving “sleep” mode when pushed. In an embodiment, when the controller is in the power-conserving mode it operates using approximately 20 microamps. When the “wake” (or active) mode the controller operates using approximately 10 milliamps. An “ERROR” light to the right of the display 196 is lit when an error has occurred.

Custom keypad 198 is just one example of many configurations possible for an input keypad. Special keys allow functions to be easily accessed by one push of a button, such as “edit times”, “skip feeds”, “status”, “messages on/off”, and “edit messages”. A number/character portion of the keyboard allows number and letter entry. “Undo” and “Clear” buttons access the indicated functions. A navigation portion of the keyboard allows navigation between and among menus and functions.

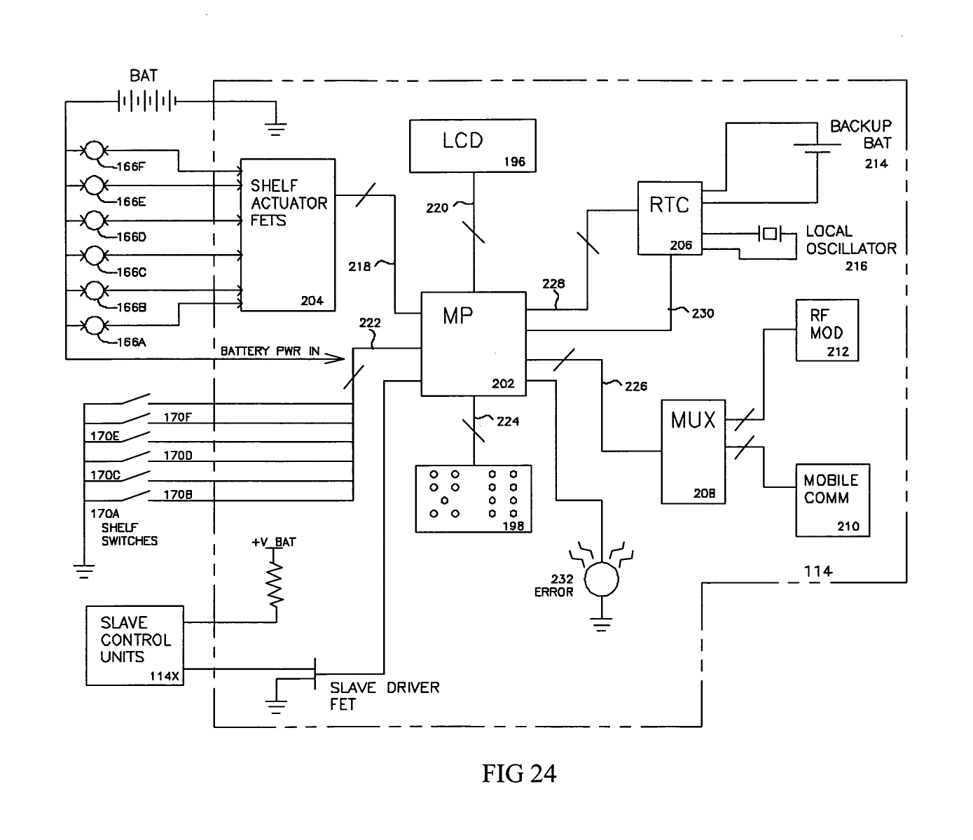

FIG. 24 is a block diagram of the controller 114, according to an embodiment. The controller 114 includes a microprocessor 202 which provides data processing capability for the controller 114. The display 196 is coupled to the microprocessor 202, as is the custom keypad 198. Error indicator 232 is a light, but in alternative embodiments, error are further indicated by an audible signal or spoken message.

Actuators 166 are each coupled to the microprocessor 202 through shelf actuator field effect transistors (FETs) 204 via parallel control lines 218. Shelf switches 170 are each coupled to the microprocessor 202 via parallel lines 222.

In an embodiment, the controller 114 is configured to communicate with other, similar controllers 114X. In an embodiment, the controller 114 is a master unit that controls one or more slave units 114X. Alternatively, controllers can be coupled such that all controllers are peers.

A real-time clock (RTC) 206, a local oscillator 216, and a backup battery 214 provide time-keeping for the microprocessor 202 via serial lines 228. The microprocessor 202 receives a wake up/interrupt signal from the RTC 206 via an interrupt line 230.

The controller 114 further includes communications interfaces 210 and 212 for wireless communications. In an embodiment, the controller 114 includes a radio frequency (RF) module 212 for communication with RF devices. A mobile communication module 210 is also included for communications with mobile devices such as cellular phones or personal data assistants (PDAs). The user can communicate with the controller remotely using the wireless communications interfaces in the same manner as if the user where in the presence of the keypad 198. The controller is remotely programmable and also remotely communicates all of the same status and error information as otherwise available.

In an embodiment, a multiplexer (MUX) 208 selects to perform wireless communications using either RF module 212 or mobile communication module 210. The mode of wireless communication s chosen by the user using the keypad 198 or a wireless communications interface as described.

The embodiments described herein are not intended to be exhaustive or to limit the invention to the precise forms, techniques, materials and/or configurations disclosed. Many modifications and variations are possible in light of the above teaching. It is to be understood that other embodiments may be utilized and operational changes may be made without departing from the scope of the present claimed invention. As such, the foregoing description of the embodiments of the inventions has been presented for the purposes of illustration and description. Many modifications and variations are possible in light of the above teaching. For example, although electronic actuators are described, it is within the scope of the invention to use mechanical actuators which function similarly. As another example, the actuators and the controller could communicate wirelessly, rather than through a wired circuit. It is intended that the scope of the inventions not be limited solely to the description above.

Designations such as “right” and “left” as used herein are not intended to be limiting. Such designations as “right”, “left”, “top”, “bottom”, and so on are used to provide a context within which to disclose the claimed invention with reference to the drawings. Such designations are not intended to limit the disclosure to any orientations of components with respect to each other, with respect to the environment, or with respect to any particular reference system.

The term “circuit” may mean, among other things, a single component (for example, electrical/electronic and/or microelectromechanical) or a multiplicity of components (whether in integrated circuit form or otherwise), which are active and/or passive, and which are coupled together to provide or perform a desired function.

In general, in the following claims, the terms used should not be construed to limit the disclosed apparatus to the specific embodiments disclosed in the specification and the claims, but should be construed to include all methods, apparatus, and systems that operate under the claims. Accordingly, the programmable automatic dispenser is not limited by the disclosure, but instead the scope of the disclosed apparatus is to be determined entirely by the claims.

While certain aspects of the programmable automatic dispenser are presented below in certain claim forms, the inventor contemplates the various aspects of the apparatus in any number of claim forms. Accordingly, the inventor reserves the right to add additional claims after filing the application to pursue any additional claim forms for other aspects of the programmable automatic dispenser.

I claim:

1. A dispensing apparatus, comprising:
a rectangular first vertical side member;
a rectangular vertical back member coupled at a first vertical edge to the first vertical side member such that the vertical back member and the first vertical side member form orthogonal vertical planes;
a rectangular second vertical side member coupled to a second vertical edge of the vertical back member such that the first vertical side member and the second vertical side member form parallel vertical planes, and such that the first vertical side member, the vertical back member, and the second vertical side member form a vertical structure;
a plurality of rectangular shelves configured to fit within the vertical structure in a first position such that each shelf in the first position defines a plane perpendicular to each of the first vertical side member, the vertical back member, and the second vertical side member;
a vertical actuator channel coupled along a vertical edge of the second vertical side member opposite the vertical back member, wherein the actuator channel comprises a plurality of trip rod slots, and wherein each trip rod slot is configured to retain a shelf in the first position; and
a plurality of actuators coupled to the actuator channel, wherein each actuator is separately controllable to release a shelf from the first position to a substantially vertical second position, wherein transitioning from the first position to the second position vertically dispenses any material resting on the shelf.

2. The apparatus of claim 1, further comprising:
a vertical hinge channel coupled along a vertical edge of the first vertical side member opposite the vertical back member;
a vertical hinge mechanism coupled along the vertical hinge channel; and
a rectangular door rotatably coupled to the hinge member along a vertical edge of the door and configured to mate with the actuator channel and to form a fourth side of the vertical structure when rotated into a closed position.

3. The apparatus of claim 2, wherein the first vertical side member, the vertical back member, and the second vertical side member share a vertical structure height dimension, and wherein the hinge mechanism and a vertical dimension of the door are each less than the vertical structure height dimension by a vertical kick panel dimension, and wherein the apparatus further comprises a rectangular kick panel coupled to the first vertical side member and the actuator channel so as to form the fourth side of the vertical structure with the door when the door is rotated into the closed position.

4. The apparatus of claim 1, further comprising a base chute unit comprising a first vertical base side member, a vertical base back member, and a second vertical base side member, wherein respective base side members are coupled to the vertical base back member, and wherein the base chute unit is configured to be removably coupled to a bottom of the vertical structure so as to form an extension of the vertical structure having a rectangular opening on one side.

5. The apparatus of claim 4, wherein the base chute unit further comprises a top cross piece configured to couple between respective vertical base side members opposite the vertical base back unit to provide stability for the base chute unit and from a top edge of the opening.

6. The apparatus of claim 5, wherein the base chute unit further comprises a chute ramp, wherein a horizontal edge of the chute ramp is coupled to an upper horizontal edge of the vertical base back member, and an opposite horizontal edge of the chute ramp forms a lower edge of the opening, and wherein the chute ramp is configured to guide dispensed material to the opening.

7. The apparatus of claim 5, wherein the base chute unit is configured to be removably coupled to the vertical structure in at least one position comprising a first position in which the opening is coplanar with and below the door when the door is in a closed position, and a second position in which the opening is coplanar with and below the vertical back member.

8. The apparatus of claim 5, wherein the base chute unit further comprises a plurality of vertical grate bars each removeably coupled between the top cross piece and the lower edge of the opening so as to form a grate over the opening.

9. The apparatus of claim 1, further comprising a rectangular top bulkhead configured to form a top of the vertical structure by coupling to an upper horizontal edge of the first vertical side member, an upper horizontal edge of the vertical back member, and an upper horizontal edge of the second vertical back member.

10. The apparatus of claim 9, further comprising a rectangular convex top configured to cover the top bulkhead, wherein the convex top presents surfaces that are angled down from the horizontal so as to cause materials including moisture and loose debris to fall off of the rectangular top.

11. The apparatus of claim 1, wherein each shelf further comprises a circumferential lip extending down from the defined plane, wherein the circumferential lip is parallel to the first vertical side member, the vertical back member, and the second vertical side member.

12. The apparatus of claim 11, wherein each shelf is concave and has a circumferential outer upper edge that defines the plane and a concave area within the outer upper edge.

13. The apparatus of claim 12, wherein each shelf further comprises a shelf rod positioned under a portion of the upper outer edge that is in parallel proximity to the vertical back member in the first position, wherein the shelf rod is parallel to the plane and rotatably coupled to the shelf and to the vertical structure so as to allow the shelf to rotate from the first position to the second position about an axis of the shelf rod.

14. The apparatus of claim 13, wherein the shelf rod is rotatably coupled to the shelf via a first end inserted through a first shelf rod hole in the circumferential lip, and a second end inserted through a second shelf rod hole in the circumferential lip.

15. The apparatus of claim 14, wherein the shelf rod is rotatably coupled to the vertical structure via the first end inserted through a shelf rod hole in a first shelf rod flange of the vertical back member and the second end inserted through a shelf rod hole in a second shelf rod flange of the vertical back member.

16. The apparatus of claim 15, wherein a first spacer is positioned over the first end of the shelf rod between the circumferential lip and the first shelf rod flange, and wherein a second spacer is positioned over the second end of the shelf rod between the circumferential lip and the second shelf rod flange.

17. The apparatus of claim 13, wherein each shelf further comprises a trip rod positioned under a portion of the upper outer edge that is parallel to and opposite the portion under which the shelf rod is positioned, wherein the trip rod is parallel to the plane, and wherein the trip rod comprises at least one trip rod latch that is connected to and projects from the trip rod, wherein the trip rod latch is releasably coupled to the vertical structure so as to retain the shelf in the first position when the trip rod latch is coupled and to release the shelf to the second position when the trip rod latch is released.

18. The apparatus of claim 17, wherein the trip rod latch is releasably coupled to the vertical structure by resting in a trip rod latch slot that is formed in the actuator channel.

19. The apparatus of claim 18, wherein the trip rod is rotatably coupled to the shelf such that in a coupled position, the trip rod is rotated so as to introduce the trip rod latch into the trip rod latch slot, and when the trip rod is rotated out of the coupled position, the trip rod latch is removed from the trip rod latch slot.

20. The apparatus of claim 19, further comprising a tension spring wound about the trip rod and configured so as to retain the trip rod in the coupled position until pressure is exerted against the tension spring, and configured to return the trip rod to the coupled position when pressure is released from the tension spring.

21. The apparatus of claim 17, wherein the trip rod comprises one trip rod latch that is releasably coupled to the vertical structure by resting in a trip rod latch slot formed in the actuator channel, and another trip rod latch that is releasably coupled to the vertical structure by resting in a trip rod latch slot formed in the hinge channel.

22. The apparatus of claim 19, further comprising a plurality of actuator levers each coupled to one of the plurality of actuators, wherein each of the actuator levers applies pressure to a trip rod latch to remove the trip rod latch from a trip rod latch slot when the actuator is activated.

23. The apparatus of claim 22, further comprising an electronic controller unit configurable to separately control each of the plurality of actuators.

24. The apparatus of claim 23, further comprising a plurality of electronic shelf sensors, each positioned to sense whether the a shelf is in the first position or the second position, wherein the plurality of shelf sensors communicate with the controller unit to report a current position for each of the plurality of switches.

25. The apparatus of claim 23, wherein the controller unit is configurable to receive user input to program separate dispensing schedules for each of the plurality of shelves.

26. The apparatus of claim 24, wherein the controller unit is configurable to convey status information to a user, the status information comprising:
date;
time;
scheduled dispensing times for each of the plurality of shelves;
a plurality of controller health state messages, comprising a battery life indication; and
a plurality of error messages.

27. The apparatus of claim 26, wherein the controller unit is configurable to convey the status information via one or more of a visual display and an audible output.

28. The apparatus of claim 23, wherein the controller unit is further configurable to communicate with at least one additional controller unit, wherein the at least one additional controller unit is configurable to control at least one additional dispenser apparatus.

29. The apparatus of claim 23, wherein the controller unit is a master unit and the at least one additional controller unit is a slave unit.

30. The apparatus of claim 23, wherein the controller unit comprises a mobile communication interface via which the controller unit communicates with a mobile communication device for conveying information and receiving instructions.

31. The apparatus of claim 23, wherein the controller unit comprises a radio frequency (RF) interface via which the controller unit communicates with an RF communication device for conveying information and receiving instructions.

32. The apparatus of claim 23, wherein controller unit is configurable to dispense material from each of the plurality of shelves at a different time, such that a lowest shelf that is in the first position is dispensed from.

33. The apparatus of claim 26 wherein the controller unit is programmable to dispense material from each of the plurality of shelves at a different time in a certain dispensing order, and wherein the plurality of error messages comprise a message indicating that the user is attempting to program a dispensing order that is not the certain dispensing order.

34. The apparatus of claim 26, wherein the status information comprises which shelves are in the first position and which shelves are in the second position, and wherein the error messages comprise a message indicating that one or more shelves is in an improper position.

35. The apparatus of claim 32, wherein if a user attempts to program the controller unit to dispense from a shelf that is not the lowest shelf in the first position, the controller unit generates an error message.

36. The apparatus of claim 1, wherein the vertical structure is comprised of metal.

37. The apparatus of claim 1, wherein the vertical structure is comprised of plastic.

38. The apparatus of claim 10, wherein the convex top is comprised of vacuum formed plastic.

39. The apparatus of claim 10, wherein the convex top is comprised of injection molded plastic.

40. The apparatus of claim 24, further comprising at least one battery container removable coupled to the top bulkhead and configured to retain batteries, wherein the battery container is electronically coupled to the controller unit and to the plurality of electronic sensors.

41. The apparatus of claim 23, wherein the controller unit is coupled to an inside surface of the door.

42. The apparatus of claim 1, wherein the door comprises a door latch, and wherein the actuator channel comprises a door latch accommodation formed in the actuator channel such that when the door is in the closed position, the door is retained in the closed position by the door latch resting in the door latch accommodation.

43. The apparatus of claim 42, wherein the door latch further comprises a lock mechanism.

44. The apparatus of claim 4, wherein a lowest shelf of the plurality of rectangular shelves extends to a bottom edge of the vertical structure when in the second position.

45. The apparatus of claim 1, wherein the first vertical side member, the vertical back member, and the second vertical side member are each between 70 inches and 90 inches high.

46. The apparatus of claim 45, wherein the first vertical side member and the second vertical side member are each between 15 inches and 20 inches wide.

47. The apparatus of claim 46, wherein the base chute unit is between 10 inches and 20 inches high.

48. An apparatus comprising:
a plurality of shelves for containing a material to be dispensed, wherein the material is contained when a shelf is in a first, horizontal position, and the material is dispensed when the shelf is deployed to a second, vertical position, and wherein the plurality of shelves are deployed in a predetermined order;
a plurality of actuators, wherein each actuator deploys one of the plurality of shelves;
a controller for controlling deployment of the plurality of shelves, wherein the controller is programmable to automatically deploy each of the shelves in at predetermined times in the predetermines order, wherein the controller signals an error if the plurality of shelves is deployed in an order other than the predetermined order.

49. The apparatus of claim 48, wherein the controller further indicates a current position of each of the plurality of shelves.

50. The apparatus of claim 48, wherein:
the plurality of shelves is supported within a vertical structure; and
the plurality of shelves are positioned one above another vertically within the vertical structure.

51. The apparatus of claim 50, wherein each of the plurality of shelves is rotatably supported within the vertical structure by a horizontal shelf rod rotatably coupled to a back edge of the shelf such that the shelf rotates about the shelf rod to the second, vertical position.

52. The apparatus of claim 51, wherein the vertical structure comprises an actuator channel, the actuator channel comprising:
a first side surface for fastening the plurality of actuators to; and
a back surface comprising a plurality of trip rod latch slots.

53. The apparatus of claim 51, wherein each shelf comprises a trip rod rotatably coupled to a bottom surface of a front edge of the shelf, wherein the trip rod comprises a trip rod latch that engages with one of the trip rod slots to support the shelf in the first, horizontal position.

54. The apparatus of claim 53, wherein the trip rod is rotated by an actuator of the plurality of actuators, and wherein the trip rod rotates to disengage the trip rod latch from the trip rod latch slot to deploy the shelf from the first, horizontal position to the second, vertical position.

55. An automatic animal feeding apparatus, comprising:
a rectangular vertical structure having a front, a left side, a back, and a right side;
a plurality of rectangular shelves configured to fit within the vertical structure in a first position, horizontal position;
a vertical actuator channel coupled along a front, vertical edge of the vertical structure, wherein the actuator channel comprises a plurality of trip rod slots, and wherein each trip rod slot is configured to retain a shelf in the first position; and
a plurality of actuators coupled to the actuator channel, wherein each actuator is separately controllable to release a shelf from the first position to a substantially vertical second position, wherein in transitioning from the first position to the second position any material resting on the shelf in the first position is dispensed vertically.

56. The apparatus of claim 55, further comprising:
a vertical hinge channel coupled along a vertical edge of the vertical structure opposite the actuator channel;
a vertical hinge mechanism coupled along the vertical hinge channel; and
a rectangular door rotatably coupled to the hinge member along a vertical edge of the door and configured to mate with the actuator channel and to form a front door to the vertical structure.

57. The apparatus of claim 55, wherein each shelf further comprises a circumferential lip, wherein the circumferential lip is in the vertical plane when the shelf is in the first position.

58. The apparatus of claim 57, wherein each shelf is concave and has a circumferential, outer upper edge that defines a horizontal plane in the first position, and a concave area within the outer upper edge.

59. The apparatus of claim 58, wherein each shelf further comprises a shelf rod positioned under a portion of the upper outer edge, wherein the shelf rod is in a horizontal plane and is rotatably coupled to the shelf and to the vertical structure so as to allow the shelf to rotate from the first position to the second position about an axis of the shelf rod.

60. The apparatus of claim 59, wherein the shelf rod is rotatably coupled to the shelf via a first end inserted through a first shelf rod hole in the circumferential lip, and a second end inserted through a second shelf rod hole in the circumferential lip.

61. The apparatus of claim 60, wherein the shelf rod is rotatably coupled to the vertical structure.

62. The apparatus of claim 58, wherein each shelf further comprises a trip rod positioned under a portion of the upper outer edge that is parallel to and opposite the portion under which the shelf rod is positioned, wherein the trip rod comprises at least one trip rod latch that is connected to and projects from the trip rod, wherein the trip rod latch is releasably coupled to the vertical structure so as to retain the shelf in the first position when the trip rod latch is coupled and to release the shelf to the second position when the trip rod latch is released.

63. The apparatus of claim 62, wherein the trip rod latch is releasably coupled to the vertical structure by resting in a trip rod latch slot that is formed in the actuator channel.

64. The apparatus of claim 63, wherein the trip rod is rotatably coupled to the shelf such that in a coupled position, the trip rod is rotated so as to introduce the trip rod latch into the trip rod latch slot, and when the trip rod is rotated out of the coupled position, the trip rod latch is removed from the trip rod latch slot.

65. The apparatus of claim 64, further comprising a tension spring wound about the trip rod and configured so as to retain the trip rod in the coupled position until pressure is exerted against the tension spring, and configured to return the trip rod to the coupled position when pressure is released from the tension spring.

66. The apparatus of claim 62, wherein the trip rod comprises one trip rod latch that is releasably coupled to the vertical structure by resting in a trip rod latch slot formed in the actuator channel, and another trip rod latch that is releasably coupled to the vertical structure by resting in a trip rod latch slot formed in the hinge channel.

67. The apparatus of claim 64, further comprising a plurality of actuator levers each coupled to one of the plurality of actuators, wherein each of the actuator levers applies pressure to a trip rod latch to remove the trip rod latch from a trip rod latch slot when the actuator is activated.

68. The apparatus of claim 67, further comprising an electronic controller unit configurable to separately control each of the plurality of actuators.

69. The apparatus of claim 68, further comprising a plurality of electronic shelf sensors, each positioned to sense whether the a shelf is in the first position or the second position, wherein the plurality of shelf sensors communicate with the controller unit to report a current position for each of the plurality of switches.

70. The apparatus of claim 68, wherein the controller unit is configurable to receive user input to program separate dispensing schedules for each of the plurality of shelves.

71. The apparatus of claim 69, wherein the controller unit is configurable to convey status information to a user, the status information comprising:
date;
time;
scheduled dispensing times for each of the plurality of shelves;
a plurality of controller health state messages, comprising a battery life indication;
a plurality of error messages.

72. The apparatus of claim 61, wherein the controller unit is configurable to convey the status information via one or more of a visual display and an audible output.

73. The apparatus of claim 68, wherein the controller unit is further configurable to communicate with at least one additional controller unit, wherein the at least one additional controller unit is configurable to control at least one additional dispenser apparatus.

74. The apparatus of claim 68, wherein the controller unit is a master unit and the at least one additional controller unit is a slave unit.

75. The apparatus of claim 68, wherein the controller unit comprises a mobile communication interface via which the controller unit communicates with a mobile communication device for conveying information and receiving instructions.

76. The apparatus of claim 68, wherein the controller unit comprises a radio frequency (RF) interface via which the controller unit communicates with an RF communication device for conveying information and receiving instructions.

77. The apparatus of claim 68, wherein controller unit is configurable to dispense material from each of the plurality of shelves at a different time, such that a lowest shelf that is in the first position is dispensed from.

78. The apparatus of claim 71 wherein the controller unit is programmable to dispense material from each of the plurality of shelves at a different time in a certain dispensing order, and wherein the plurality of error messages comprise a message indicating that the user is attempting to program a dispensing order that is not the certain dispensing order.

79. The apparatus of claim 71, wherein the status information comprises which shelves are in the first position and which shelves are in the second position, and wherein the error messages comprise a message indicating that one or more shelves is in an improper position.

80. The apparatus of claim 55, wherein the vertical structure is comprised of metal.

81. The apparatus of claim 55, wherein the vertical structure is comprised of plastic.

82. The apparatus of claim 58, wherein a lowest shelf of the plurality of rectangular shelves extends to a bottom edge of the vertical structure when in the second position.
